(19) United States
(12) Patent Application Publication
(10) Pub. No.: US 2026/0219599 A1
(43) Pub. Date: Jul. 30, 2026

(54) CONDUCTIVE ROLLER, PROCESS CARTRIDGE AND ELECTROPHOTOGRAPHIC IMAGE FORMING APPARATUS

(71) Applicant: CANON KABUSHIKI KAISHA, Tokyo (JP)

(72) Inventors: KATSUYA KODAMA, Kanagawa (JP); YUICHI KIKUCHI, Shizuoka (JP); ATSUSHI UEMATSU, Shizuoka (JP); SATORU NISHIOKA, Shizuoka (JP); YASUHIRO FUSHIMOTO, Kanagawa (JP); HIROAKI WATANABE, Kanagawa (JP); MASATSUGU HONGO, Shizuoka (JP)

(21) Appl. No.: 19/457,868

(22) Filed: Jan. 23, 2026

(30) Foreign Application Priority Data
Jan. 30, 2025 (JP) 2025-014185
Jan. 14, 2026 (JP) 2026-004514

(51) Int. Cl. G03G 15/02; C08K 3/04; C08L 23/16; G03G 21/18

(52) U.S. Cl. CPC G03G 15/0233; C08K 3/04; C08L 23/16; G03G 21/1814; C08K 2201/001; C08L 2203/20; C08L 2205/02

(57) ABSTRACT

Provided is a conductive roller, including: a support member having a conductive outer surface; and a conductive layer disposed on the support member. The conductive layer includes a matrix which contains first rubber, and a plurality of domains. The volume resistivity of the matrix is in a specific range. The plurality of domains include a domain A which has a core-shell structure and of which centroid of volume exists in the core. An impedance of the conductive roller satisfies a specific relationship. On the outer surface of the conductive layer, an area ratio of the domains is large, and the portion occupied by the domains is cut off by the matrix portion. Out of the domain portions on the outer surface of the conductive layer, a component of the shell exist directly under a portion where a component of the core exists.

### BACKGROUND

### Field of the Technology

The present disclosure relates to a conductive roller, a process cartridge, and an electrophotographic image forming apparatus, which can be used for electrophotography.

### Description of the Related Art

In an electrophotographic image forming apparatus, conductive members, such as a transfer member and a developing member as represented by a charging member, are used. As an example of the conductive members, a conductive roller including a conductive support member and a conductive layer disposed on the support member is known. The conductive member plays a role of transporting charges from the conductive support member to a surface of the conductive member, and provides charges to a contacted object by discharging or triboelectric charging. The charging member is a member that generates discharge between the charging member and an electrophotographic photosensitive member, so as to charge a photosensitive drum.

The charging member is a member that generates discharge between the charging member and the electrophotographic photosensitive member, so as to charge the surface of the electrophotographic photosensitive member, and therefore it is necessary to perform uniform charging on the electrophotographic photosensitive member. Recently a conductive member that can form high quality images for a long period of time is needed in an electrophotographic image forming process which has become faster, without performing pre-exposure, and has a longer service life.

Japanese Patent Application Publication No. 2024-013026 discloses a conductive roller which stably charges a photosensitive drum, even in the case of being applied to the high-speed electrophotographic image forming process. In the conductive roller having a conductive layer, the conductive layer includes a matrix of a first phase containing first rubber, and a domain of a second phase containing second rubber and conductive particles in the matrix, and the area ratio of the first phase and the second phase is within a specific range.

Japanese Patent Application Publication No. 2020-166210 discloses a conductive member which stably charges a charged member, even in a case of being applied to the high-speed electrophotographic image forming process. This conductive member has a conductive layer which includes a matrix containing first rubber and a plurality of domains dispersed in the matrix, and the domain contains second rubber and an electronic conductive agent.

### SUMMARY

Using the conductive roller according to Japanese Patent Application Publication No. 2024-013026, the present inventors attempted to form images for a long period of time in a recent electrophotographic image forming process which has a faster speed, without performing pre-exposure, and has a longer service life. As a result, it was confirmed that this conductive roller has a problem in charging the charged member uniformly. Specifically, when the micro-potential unevenness formed on the surface of the charged member cannot be sufficiently made uniform before reaching the charging step, an image that does not have to be formed (“ghost image”) may be formed overlapping with the original image due to this potential unevenness.

Further, using the conductive member according to Japanese Patent Application Publication No. 2020-166210 as the charging member, the present inventors attempted to form images for a long period of time in a electrophotographic image forming process which has a faster speed recently, without performing pre-exposure, and has a longer service life. As a result, this conductive member was found to excel in uniform charging performance on a charged member, even in this faster electrographic image forming process. Specifically, a ghost image was not formed.

However, the present inventors recognized that the problem remains in terms of supporting a longer service life. Specifically, in some cases, an adhering substance, such as toner, which remains on the photosensitive member without being transferred onto paper, is noticeably deposited on the surface of the charging member, an over discharge is generated at a location where the adhering substance is deposited, whereby a white spot image is generated.

The present disclosure provides a conductive roller that can form high quality images over a long period of time, even when this conductive roller is applied to the electrophotographic image forming process of the main body having a longer service life, without performing pre-exposure and faster speed. Also, the present disclosure provides a process cartridge to form high quality electrophotographic images. Furthermore, the present disclosure provides an electrophotographic image forming apparatus that can form high quality electrophotographic images.

The present disclosure relates to a conductive roller, comprising: a support member having a conductive outer surface; and a conductive layer disposed on the outer surface of the support member, wherein the conductive layer comprises a matrix which comprises first rubber, and a plurality of domains dispersed in the matrix, wherein volume resistivity of the matrix is 1.00×10⁸ to 1.00×10¹² Ω·cm, the plurality of domains comprises a plurality of domains A, and each of the domains A satisfies <Condition 1> to <Condition 3> below: <Condition 1> each domain A has a core-shell structure constituted of a core and a shell surrounding the core, the core comprises second rubber, which is different from the first rubber, and an electronic conductive agent, and the shell comprises third rubber, which is different from the first rubber and the second rubber; <Condition 2> a centroid of volume of each domain A exists inside the core of the domain A; <Condition 3> on a cross section of each domain A passing through the centroid of volume, volume resistivity of the core of the domain A is not more than 1.00×10⁴ Ω·cm, and volume resistivity of the shell is more than 1.00×10¹² Ω·cm; wherein in a case where a platinum electrode is directly disposed on an outer surface of the conductive roller, impedance is measured by applying AC voltage having a 1V amplitude between the outer surface of the support member and the platinum electrode in an environment of a 23° C. temperature and 50% relative humidity, while changing a frequency in a range of 1.0×10⁻² to 1.0×10⁷ Hz, and the frequency is plotted on an abscissa and the impedance is plotted on an ordinate of a log-log graph, a slope at the frequency range of 1.0×10⁵ to 1.0×10⁶ Hz is −0.80 to −0.30, and the impedance in the frequency range of 1.0×10⁻² to 1.0×10¹ Hz is 1.00×10³ to 1.00×10⁷Ω, wherein the outer surface of the conductive layer is constituted of a portion M originated from the matrix, and a portion D originated from the domain, and in a case where a 100 μm square observation region is disposed on the outer surface of the conductive layer, such that one side of the square is parallel with a circumferential direction of the conductive roller, at a total of 12 locations of the center of L (Lis the length of the conductive layer in a longitudinal direction) and L/4 from each end toward the center at 90° intervals in the circumferential direction, and in this state, a ratio (R2/R1), which is a ratio of an area R2 where the portion D occupies with respect to an area R1 where the portion M occupies in the observation region, is at least 0.50, wherein in a case where 99 lines are drawn in the observation region, along a rotation shaft of the conductive roller, at 1 μm intervals in the circumferential direction of the conductive roller, a plurality of lines, out of the lines, cross the portion M, and in a case where in each line crossing the portion M, a line portion overlapping with the portion M is assumed to be a line segment LS, a ratio of the number of line segments LS, of which length is at least 20 μm, with respect to the total number of line segments LS, is not more than 5%, and wherein in a case where a portion containing the second rubber and the electronic conductive agent, out of the portion D, is assumed to be a portion C, a portion E which contains the third rubber exists directly under the portion C on the outer surface of the conductive layer in a cross-sectional view of the conductive layer in a thickness direction thereof.

The present disclosure relates to a process cartridge detachably attached to a main body of an electrophotographic image forming apparatus, the process cartridge, comprising: an electrophotographic photosensitive member; and a charging member disposed such that the electrophotographic photosensitive member is chargeable, wherein the charging member is the above conductive roller.

The present disclosure relates to an electrophotographic image forming apparatus, comprising: an electrophotographic photosensitive member; and a charging roller disposed such that the electrophotographic photosensitive member is chargeable, wherein the charging roller is the above conductive roller.

Features of the present disclosure will become apparent from the following description of embodiments with reference to the attached drawings. The following description of embodiments are described by way of example.

### BRIEF DESCRIPTION OF THE DRAWINGS

FIGS. 1A to 1C are diagrams for describing the surface potential unevenness.

FIG. 2 is a schematic diagram depicting a structure of a domain.

FIG. 3 is a schematic diagram depicting a charging roller.

FIG. 4 is a schematic diagram for describing a structure of a conductive layer.

FIGS. 5A and 5B are diagrams for describing a cross-sectional cut out direction.

FIG. 6 is a graph indicating impedance characteristics.

FIG. 7 is a graph for describing behavior of impedance.

FIGS. 8A and 8B are schematic diagrams for describing observation areas of a conductive layer.

FIG. 9 is a diagram for describing calculation of a ratio of a number of line segments LS.

FIGS. 10A and 10B are cross-sectional views depicting a conductive layer.

FIG. 11 is a schematic diagram depicting a process cartridge.

FIG. 12 is a schematic diagram depicting an electrophotographic apparatus.

FIG. 13 is a schematic diagram depicting a charging roller on which an electrode is formed.

FIG. 14 is a cross-sectional view depicting a measurement electrode.

FIG. 15 is a schematic diagram depicting an impedance measurement system.

FIG. 16 is a schematic diagram depicting an image for evaluating a ghost image.

FIGS. 17A and 17B are diagrams for describing a centroid of volume of a domain A.

### DESCRIPTION OF THE EMBODIMENTS

In the present disclosure the notations “from XX to YY” and “XX to YY” representing a numerical value range signify, unless otherwise specified, a numerical value range that includes the lower limit and the upper limit of the range, as endpoints. In a case where numerical value ranges are described in stages, the upper limits and the lower limits of the respective numerical value ranges can be combined arbitrarily. In the present disclosure, for instance, a wording such as “at least one selected from the group consisting of XX, YY and ZZ” encompasses XX, YY and ZZ, a combination of XX and YY, a combination of XX and ZZ, a combination of YY and ZZ, and a combination of XX, YY and ZZ. In the case where XX represents a group, a plurality of members may be selected from XX, and the same is true for YY and ZZ.

Embodiments of the present disclosure will be described in detail with reference to the drawings. Composing elements described in the embodiments, however, are merely examples, and are not intended to limit the scope of the present disclosure thereto.

The present disclosure not only solves the problem of generating a ghost image, which is a problem to increase speed without performing pre-exposure, in the electrophotographic process having a longer service life and faster speed, but also suppresses the generation of white spot images, which may be generated in the use [of the electrophotographic process] over a long period of time.

The present inventors estimated that for the following reasons, the conductive roller according to Japanese Patent Application Publication No. 2020-166210 cannot implement suppression of the generation of white spot images.

The contaminating substances in this disclosure are toner and external additives which are not transferred to paper or to an intermediate transfer member in the transfer processing of the electrophotographic image forming process, and which remain on the surface of the photosensitive drum, and reach and adhere to the charging member.

The toner and external additives often have insulation properties to hold predetermined charges that are electrostatically transferred from the developing roller to the photosensitive drum in the developing process. The toner and external additives remaining on the surface of the photosensitive drum, without being transferred from the photosensitive drum to the paper and intermediate transfer member, are influenced by discharge at the transfer roller and rubbing with paper before reaching the charging member again, and are charged in a predetermined distribution of positive and negative charges.

The charging member (hereafter also called “charging roller”), on the other hand, is a member that generates a potential difference between the charging member and the surface of the photosensitive drum when DC voltage is applied, in order to discharge electricity to the photosensitive drum. Therefore it is difficult to prevent the adhering of components, of which polarity (negative/positive) is opposite of the polarity of the charging bias which generates the above potential difference, to the charging roller side due to the electrostatic attraction. In other words, for the charging member which should be used over a long period of time, it is demanded to suppress abnormal discharge caused by the contaminating substances, even if the contaminating substances adhere to the charging roller, as described below.

Next, white spot images, which are generated by abnormal discharge due to contaminating substances, will be described. The discharge phenomena is generated between the charging roller and the photosensitive member based on Paschen's law, and the photosensitive member is charged with negative or positive charges in accordance with the applied voltage. The discharge is generated by neutral air that is ionized in the electric field, hence charges having the opposite polarity are also generated at the same time. In other words, the positive or negative charges having opposite polarity of discharge are moved toward the surface of the charging roller by the electric field. In a state where no contaminating substances adhere to the surface of the charging roller, the charges on the surface of the charging roller normally leak to the conductive support member side because of the conductivity of the charging roller, even if the surface of the charging roller is charged up with charges having an opposite polarity.

However if contaminating substances (e.g. toner, external additives) having insulation properties adhere to the surface of the charging roller, the charges having opposite polarity of discharge moving toward the surface of the charging roller, are trapped on the surface without leaking to the conductive support member. Here charges having opposite polarities exist between the contaminating substances charged with opposite polarity of the discharge (charged with the opposite polarity of the voltage applied to the charging roller), and the surface of the charging roller around the area where the contaminating substances adhere, hence a very strong electric field is generated. This very strong electric field may, in some cases, generate an abnormally strong discharge.

Therefore if the charges, which are charged up due to adhering contaminating substances, can be moved toward the conductive support member side, the abnormally strong charges may not be generated, and accordingly white spot images may not be generated.

Based on the above consideration, the reason why both the suppression of ghost images and the suppression of the generation of white spot images in image formation over a long period of time cannot be implemented in the case of using the conductive member according to Japanese Patent Application Publication No. 2024-013026 as the charging member will be described below.

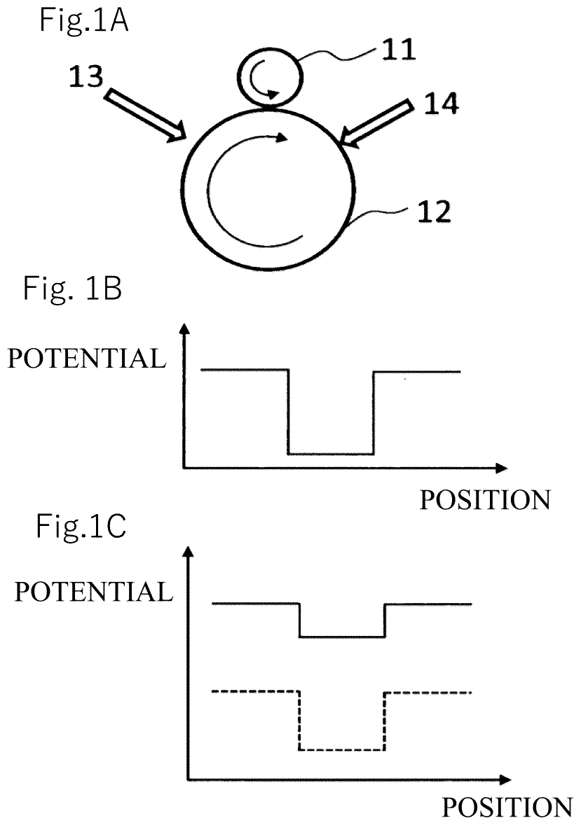

The phenomena of the generation of ghost images will be described with reference to FIGS. 1A to 1C. FIGS. 1A to 1C are diagrams for describing the surface potential unevenness. FIG. 1A is a schematic diagram depicting an electrophotographic process, FIG. 1B is a graph indicting a surface potential on the surface of the photosensitive drum, and FIG. 1C is a graph indicating a charging potential in the case of using the charging member according to Japanese Patent Application Publication No. 2024-013026. In FIG. 1C, the solid line portion indicates the charging potential on the surface of the charging member, and the broken line portion indicates the surface potential on the surface of the photosensitive drum.

In FIG. 1A, 11 indicates a charging member, 12 indicates a photosensitive drum, 13 indicates a surface potential measuring portion before the charging process, and 14 indicates the surface potential measuring portion after the charging process. Normally the surface potential of the photosensitive drum after the transfer process has unevenness, as indicated in FIG. 1B. Therefore the unevenness of the surface potential enters the charging process, and the charging potential unevenness, as indicated by the solid line in FIG. 1C, is formed according to the above mentioned surface potential unevenness. As a result, a ghost image is generated. Here if the charging member has a charging function sufficient enough to make the surface potential unevenness uniform, a ghost image may not be generated.

The conductive roller according to Japanese Patent Application Publication No. 2024-013026 includes a matrix and a plurality of domains dispersed in the matrix, and this domain contains an electronic conductive agent. Since the matrix has intermediate resistance, sufficient charges cannot be stored in the domain. This is the probable reason why the discharge loss cannot be suppressed, and the problem of the generation of a ghost image cannot be sufficiently improved.

The conductive member according to Japanese Patent Application Publication No. 2020-166210 includes a matrix and a plurality of domains dispersed in the matrix, and this domain contains an electronic conductive agent. By electrically separating each domain by an insulating region (matrix), sufficient charges can be more easily stored in the domain. Thereby leaking of discharge is suppressed, and if a single discharge amount is improved at the same time, the generation of a ghost image is more easily suppressed.

However, in Japanese Patent Application Publication No. 2020-166210, if the matrix exists as the insulating region, it is impossible to move the charge, which are charged up in opposite polarity by the discharge to the contaminating substances deposited on the surface of the charging member, toward the conductive support member side. As a result, white spot images are more easily generated in the image formation over a long period of time. In other words, the present inventors estimated that the existence of the matrix as an insulating region suppresses the generation of the ghost images, but is also the cause of generating the white spot images in the image formation over a long period of time.

Therefore the present inventors verified that the charge up of the adhering contaminating substances is suppressed by adjusting the volume resistivity of the matrix, and confirmed that if the volume resistivity of the matrix is set to 1.0×10¹² Ω·cm or less, the charges charged upon the contaminating substances adhering to the charging member can be quickly moved toward the conductive support member via the matrix, and the generation of the white spot images can be suppressed. However if the volume resistivity of the matrix is set to 1.0×10¹² Ω·cm or less, the ghost images are more easily generated.

As a consequence, the present inventors recognized that it is not easy to implement both the suppression of the generation of ghost images to support higher speeds, and suppressing the generation of white spot images in the image formation over a long period of time. The present inventors also recognized that in the matrix-domain structure, in some cases, strong discharge may propagate in the longitudinal direction of the conductive roller, and potential may become higher than a predetermined potential (transverse discharge) depending on the state of the presence of the domains on the surface of the conductive roller. If the transverse discharge is generated, color loss may be generated in the rotation axis direction of the conductive roller.

Then the present inventors continued intensive studies to obtain a conductive roller which not only implements both suppression of the generation of ghost images and suppression of the generation of white spot image, but also suppresses the generation of the transverse discharge. As a result, the present inventors found that the above mentioned requirements can be well satisfied if the following Requirements (1) to (5) are satisfied in the conductive layer having a matrix-domain structure.

The present disclosure will now be described in detail with reference to the drawings.

### Conductive Roller

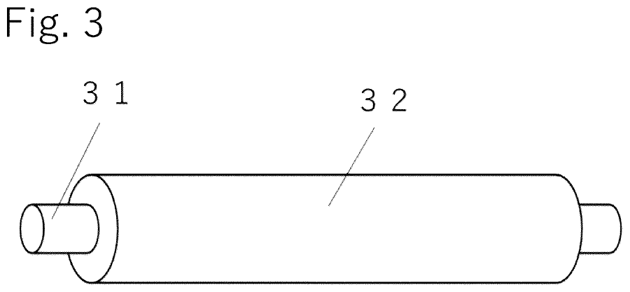

The conductive roller includes a support member having a conductive outer surface, and a conductive layer disposed on the outer surface of this support member. The conductive roller may be an electrophotographic roller, for example. The conductive roller will now be described using an electrophotographic roller as an example. FIG. 3 is a schematic external view of an electrophotographic roller. This electrophotographic roller includes a conductive layer 32 on an outer periphery of the support member (shaft core) 31. The conductive layer 32 is an elastic layer, for example. Both ends of the support member 31 may be exposed without being coated by the conductive layer 32. The electrophotographic roller may be a charging roller. The charging roller is disposed in the image forming apparatus, as charging means for charging a photosensitive member, and has conductivity.

### Support Member

The support member has a conductive outer surface. A material constituting the support member may be selected from materials known in the field of electrophotographic members, and materials that can be used for the electrophotographic members. For example, aluminum, stainless steel, synthetic resin having conductivity, such a metal as iron, and such an alloy as a copper may be used. Further, oxidation and plating treatment using chrome, nickel or the like may be performed thereon.

For the plating, both electric plating and electroless plating may be used. However electroless plating is preferable in terms of dimensional stability. For the types of the electroless plating used here, nickel plating, copper plating, gold plating and many other alloy plating can be used. The thickness of the plating is preferably 0.05 μm or more, and is more preferably 0.1 to 30 μm if the balance of the operation efficiency and the rust prevention capability is considered.

The shape of the support member is not especially limited, but is preferably a cylindrical shape, for example. The cylindrical shape may be a solid cylindrical shape or a hollow cylindrical shape (tubular shape). The outer diameter of the support member is preferable φ3 mm to φ10 mm.

### Conductive Layer

### Matrix-Domain Structure

The conductive layer includes a matrix containing a first rubber, and a plurality of domains dispersed in the matrix. In other words, the conductive layer has a matrix-domain structure. In the conductive layer, the domain has a core-shell structure, for example, where an electronic conductive agent (conductive particles), such as carbon black, is filled in the core portion. The conductive layer preferably constitutes the outer surface of the conductive roller.

### Core-Shell Structure of Domain

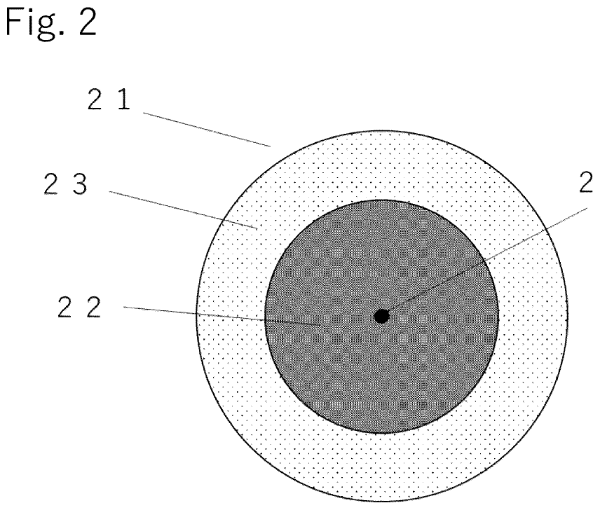

An example of the core-shell structure of a domain 21 is depicted in FIG. 2. FIG. 2 is a cross-sectional view of the domain 21 sectioned at a plane passing through a centroid of the volume 24. In FIG. 2, the domain 21 has a core-shell structure constituted of a core 22 and a shell 23 which surrounds the core 22. In FIG. 2, the amount of the electronic conductive agent is indicated by the density of the shading, which indicates that the amount of the electronic conductive agent is higher as the shading is darker.

The conductive layer satisfies the following Requirements (1) to (5).

### Requirement (1):

The conductive layer includes a matrix which contains first rubber and a plurality of domains dispersed in the matrix, and the volume resistivity of the matrix is 1.00×10⁸ to 1.00×10¹² Ω·cm.

### Requirement (2):

The plurality of domains dispersed in the matrix includes a plurality of domains A, and each domain A satisfies the following <Condition 1> to <Condition 3>.
<Condition 1> Domain A has a core-shell structure constituted of a core and a shell surrounding the core. The core contains second rubber which is different from a first robber and an electronic conductive agent, and the shell contains a third rubber which is different from the first rubber and the second rubber.
<Condition 2> A centroid of volume of the domain A exists inside the core of the domain.
<Condition 3> On a cross-section of the domain A passing through the centroid of volume, the volume resistivity of the core of the domain A is 1.00×10⁴ Ω·cm or less, and the volume resistivity of the shell is more than 1.00×10² Ω·cm.

### Requirement (3):

A platinum electrode is disposed directly on an outer surface of the conductive roller, and the impedance is measured in an environment of a 23° C. temperature and a 50% relative humidity, by applying an AC voltage having a 1V amplitude between the outer surface of the support member and the platinum electrode, while changing the frequency in a range of 1.0×10⁻² to 1.0×10⁷ Hz. When the frequency is plotted on the abscissa and the impedance is plotted on the ordinate of a log-log graph, the following requirements (3-1) and (3-2) are satisfied.
Requirement (3-1): A slope in the frequency range 1.0×10⁵ to 1.0×10⁶ Hz is −0.80 to −0.30.
Requirement (3-2): The impedance in the frequency range 1.0×10⁻² to 1.0×10¹ Hz is 1.00×10³ to 1.00×10⁷Ω.

### Requirement (4):

The outer surface of the conductive layer is constituted of a portion M originated from the matrix, and portion D originated from the domain. A 100 μm square observation region is disposed on the outer surface of the conductive layer, such that one side of the square is parallel with the circumferential direction of the conductive roller. This square is disposed at a total of 12 locations of the center of L (L is the length of the conductive layer in the longitudinal direction) and L/4 from each end toward the center at 90° intervals in the circumferential direction. In this state, the following Requirements (4-1) and (4-2) are satisfied.

### Requirement (4-1):

When an area R1 is an area where the portion M occupies in the observation region and an area R2 is an area where portion D occupies in the observation region, the ratio thereof (R2/R1) is 0.50 or more.

### Requirement (4-2):

99 lines are drawn in the observation region, along the rotation shaft of the conductive roller, at 1 μm intervals in the circumferential direction of the conductive roller. Here a plurality of lines, out of the lines, cross the portion M. In each line crossing the portion M, a line portion overlapping with the portion Mis assumed to be line segment LS. In this case, a ratio of the number of segments LS, of which length is 20 μm or more, with respect to the total number of line segments LS, is 5% or less.

### Requirement (5):

When the portion containing the second rubber and the electronic conductive agent, out of the portion D, assumed to be s a portion C, a portion E which contains the third rubber exists directly under the portion C on the outer surface of the conductive layer in the cross-sectional view of the conductive layer in the thickness direction.

Requirements (1) to (5) will be described in detail.

### Requirement (1)

By setting the volume resistivity of the matrix to 1.00×10¹² Ω·cm or less, charges that are charged up on the contaminating substances adhering to the conductive roller can be more easily moved toward the support member. The charged up charges have opposite polarity of the voltage applied from the support member side, hence the charges are attracted to the electric field, and move toward the support member. Therefore if the volume resistivity of the matrix is set to the above mentioned range, the charged up charges can more easily move via the matrix. This makes it easier to move the charged up charges toward the support member side more quickly via the matrix, and suppress the generation of white spot images.

The volume resistivity of the matrix is preferably 1.00×10¹¹ Ω·cm or less, and is more preferably 1.00×10¹⁰ Ω·cm or less. The lower limit is not especially limited, but may be 1.00×10⁸ Ω·cm or more. The volume resistivity of the matrix is 1.00×10⁷ to 1.0×10¹² Ω·cm, for example, preferably is 1.00×10⁸ to 1.0×10¹¹ Ω·cm, and even more preferably is 1.00×10⁸ to 1.00×10¹⁰ Ω·cm.

### Adjustment Method for Volume Resistivity of Matrix

The volume resistivity of the matrix can be adjusted by the composition of the rubber for forming the matrix (hereafter also called “MRC”). For example, a rubber material in the above mentioned volume resistivity range is used, or the volume resistivity is controlled to the above mentioned range using an additive required for a rubber material having high volume resistivity depending on the need.

For example, a first rubber that can be used for MRC is at least one rubber selected from the group consisting of natural rubber, butadiene rubber, butyl rubber, acrylonitrile-butadiene rubber, urethane rubber, silicon rubber, fluoro rubber, isoprene rubber, chloroprene rubber, styrene-butadiene rubber, ethylene-propylene rubber, polynorbornene rubber and hydrin rubber. Particularly the first rubber is preferably at least one rubber selected from the group consisting of acrylonitrile-butadiene rubber, chloroprene rubber and hydrin rubber, and more preferably at least one rubber selected from the group consisting of acrylonitrile-butadiene rubber and chloroprene rubber.

If necessary, the matrix may contain fillers, processing aids, cross-linking agents, cross-linking aids, cross-linking accelerators, cross-linking acceleration aids, cross-linking retarders, antioxidants, softeners, dispersing agents, colorant, or electronic conductive agents. To set the volume resistivity of the matrix to the above mentioned range, it is preferable that the matrix does not contain such electronic conductive agents as carbon black.

### Measurement Method for Volume Resistivity of Matrix

To measure the volume resistivity, a predetermined thickness (e.g. 1 μm) of a thin slice containing the matrix-domain structure is cut out from the conductive layer, and a micro-probe of the scanning probe microscope (SPM) or an atomic force microscope (AFM) is contacted to the matrix and domain of the thin slice.

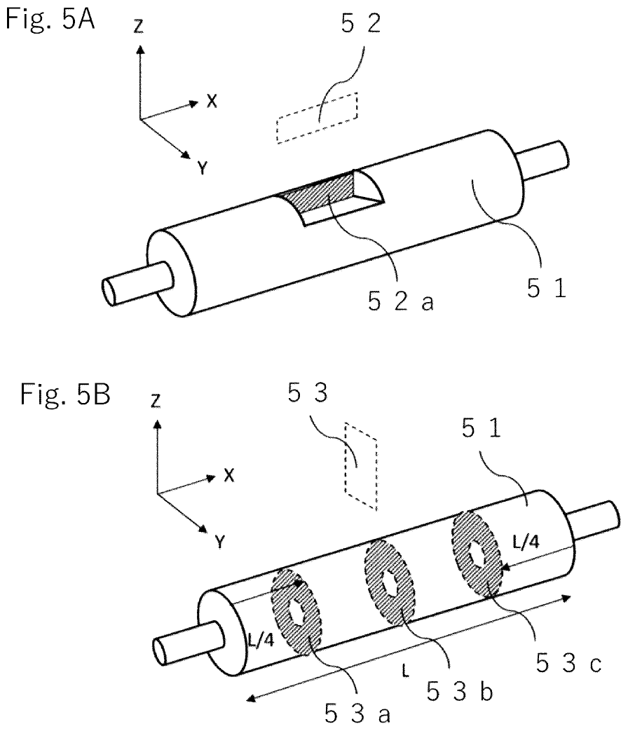

The thin slice is cut out from the conductive layer such that the thin slice includes at least a part of a cross-section 52a parallel with the XZ plane, where the X axis is the longitudinal direction of the electrophotographic member 51, the Z axis is the thickness direction of the conductive layer, and the Y axis is the circumferential direction, as illustrated in FIG. 5A, for example. The thin slice 53 may also be cut out such that the thin slice includes at least a part of the YZ plane (e.g. 53a, 53b, 53c) vertical to the axial direction of the conductive member, as illustrated in FIG. 5B. In the present disclosure, the thin slice was cut out as illustrated in FIG. 5B. Cutting out is performed, for example, with a sharp razor, a microtome, a focusing ion beam (FIB) or the like. In the present disclosure, a microtome was used.

To measure the volume resistivity, one surface of the thin slice, which was cut out from the conductive layer, is grounded. Then the micro-probe of the scanning probe microscope (SPM) or the atomic force microscope (AFM) is contacted to the matrix portion of the surface of the thin slice on the opposite side of the grounded surface, and a 50 V DC voltage is applied for 5 seconds, then an arithmetic average value is calculated from the values when the ground current value is measured for 5 seconds. The electric resistance value is calculated by dividing the applied voltage by this calculated value. Finally, using the film thickness of the thin slice, the resistance value is converted into the volume resistivity. Here the SPM and AFM can measure the film thickness of the thin slice together with the resistance value. The specific procedure will be described later.

### Requirement (2)

A plurality of domains include a plurality of domains A, and each domain A satisfies the following <Condition 1> to <Condition 3>.
<Condition 1> The domain A has a core-shell structure constituted of a core and a shell surrounding the core. The core contains second rubber which is different from the first rubber and an electronic conductive agent, and the shell contains a third rubber which is different from the first rubber and the second rubber.
<Condition 2> A centroid of volume of the domain A exists inside the core of the domain A.
<Condition 3> On a cross-section of the domain A passing through the centroid of volume, the volume resistivity of the core of the domain Ais 1.00×10⁴ Ω·cm or less, and the volume resistivity of the shell is more than 1.00×10¹² Ω·cm.

The above conditions will be described in detail below.

### Condition 1

A domain A has a core-shell structure. By the core containing the second rubber and the electronic conductive agent, the transporting path of charges can be more effectively limited to the path via the domain, while suppressing the movement of the unintended charges. The shell portion is formed of the third rubber, hence the core can be electrically insulated by the shell, and a sufficient amount of charges can be more easily stored without allowing leakage of charges to the matrix.

### Condition 2

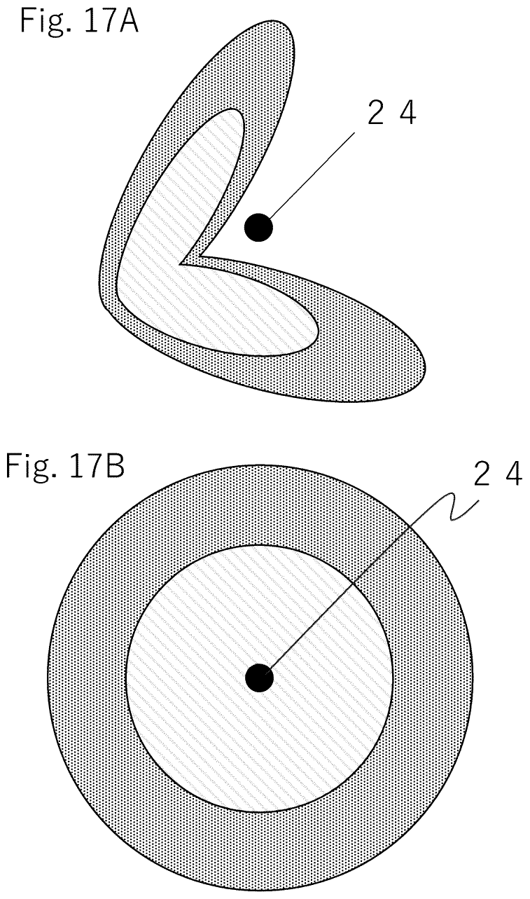

A centroid of volume of the domain A exists inside the core of the domain A. The shape of the domain A is preferably close to the shape of a sphere. The centroid of volume preferably exists inside the core of the domain A. For example, FIG. 17A indicates a domain where the centroid of volume 24 does not exist inside the core, and FIG. 17B indicates a domain where the centroid of volume 24 exists inside the core. The centroid of volume of the domain A existing inside the core indicates that the domain A has the shape close to a sphere. If the domain A has a shape close to a sphere, an effect of reducing non-uniformity of the electric field between domains can be obtained.

### Condition 3

### Volume Resistivity of Core

On the cross-section of the domain A passing through the centroid of volume, the volume resistivity of the core is 1.00×10⁴ Ω·cm or less. If the volume resistivity of the core is 1.00×10⁴ Ω·cm or less, the transporting path of charges can be more effectively limited to the path via the domain, while suppressing the movement of unintended charges in the matrix.

It is preferable that the volume resistivity of the core is 1.00×10² Ω·cm or less. The amount of charges that move in the domain can be dramatically increased if the volume of resistivity of the core is reduced to this range. This makes it easier to control the impedance of the conductive layer in the 1.0×10⁻² to 1.0×10¹ Hz frequency to an even lower range, such as 1.00×10⁵Ω or less. As a result, the transporting path of the charges can be limited to the path via the domain even more effectively. The volume resistivity of the core is 1.00×10¹ to 1.00×10⁴ Ω·cm, and is preferably 1.00×10¹ to 1.00×10² Ω·cm.

The electronic conductive agent that is used for controlling the volume resistivity of the core to 1.00×10¹ to 1.00×10⁴ Ω·cm is not especially limited, but preferably is an electronic conducive agent that can largely change the volume resistivity from high resistance to low resistance by the amount to be dispersed.

Examples of the electronic conductive agent blended with the core is carbon black, graphite, oxide (e.g. titanium oxide, tin oxide), metal (e.g. Cu, Ag), or particles which are coated with oxide or metal on the surface to be conductive. If necessary, two or more types of these conductive agents may be blended at an appropriate ratio. The electronic conductive agent preferably contains carbon black or tin oxide. It is preferable that the electronic conductive agent contains carbon black, and is more preferable that the electronic conductive agent is carbon black.

The volume resistivity of the core can be adjusted by the core containing an electronic conductive agent, and adjusting the conductivity thereof to a predetermined value. Specifically, the volume resistivity of the core can be adjusted by appropriately selecting a type of electronic conductive agent, and an amount of the electronic conductive agent to be added.

Among the above mentioned electronic conductive agents, it is preferable to use a conductive carbon black, since the affinity to rubber is high and the distance between particles of the electronic conductive agent can be easily controlled. The type of carbon black to blend into the domain is not especially limited. For example, gas furnace black, oil furnace black, thermal black, lamp black, acetylene black, ketjen black and the like may be used.

In particular, conductive carbon black, of which DBP oil absorption, which provides high conductivity to the core, is from 40 cm³/100 g to 170 cm³/100 g, can be suitably used. The content of the electronic conductive agent, such as conductive carbon black, is preferably from 20 parts by mass to 150 parts by mass, and is more preferably from 50 parts by mass to 100 parts by mass when the second rubber contained in the core is 100 parts by mass.

The volume resistivity of the core can be adjusted by the content of the electronic conductive agent in the core. For example, in the case of using a conductive carbon black, of which DBP oil absorption is from 40 cm³/100 g to 170 cm³/100 g, as the electronic conductive agent, the content of the electronic conductive agent in the core is preferably from 20 parts by mass to 150 parts by mass, and is more preferably from 50 parts by mass to 100 parts by mass when the second rubber contained in the core is 100 parts by mass.

In the cross section of the conductive layer, the ratio of a sectional area of the electronic conductive agent contained in the core, with respect to the sectional area of the core, is preferably 17.0 area % or more, and is more preferably 20.0 area % or more, for example. The upper limit of the ratio of the sectional area of the electronic conductive agent is not especially limited, but may be 17.0 to 30.0 area %, preferably 20.0 to 30.0 area %, and more preferably 23.0 to 28.0 area %, for example.

It is preferable that a large amount of the conductive agent is blended compared with the case of the conductive agent used for a general electrophotographic member. Thereby the volume resistivity at the core can be controlled more easily to a desired range. If necessary, the core may contain fillers, processing aids, cross-linking aids, cross-linking accelerators, antioxidants, cross-linking acceleration aids, cross-linking retarders, softeners, dispersing agents, colorants or the like.

The second rubber used as the core is, for example, at least one rubber selected from the group consisting of natural rubber, butadiene rubber, butyl rubber, acrylonitrile-butadiene rubber, urethan rubber, silicon rubber, fluoro rubber, isoprene rubber, chloroprene rubber, styrene-butadiene rubber, ethylene-propylene rubber, polynorbornene rubber, ethylene-propylene-diene rubber, nitrile rubber and hydrogenated nitrile rubber.

Particularly the second rubber is more preferably at least one rubber selected from the group consisting of natural rubber, butadiene rubber, butyl rubber, acrylonitrile-butadiene rubber, urethane rubber, silicone rubber, fluoro rubber, isoprene rubber, chloroprene rubber, styrene-butadiene rubber, ethylene-propylene rubber and polynorbornene rubber is preferable, and at least one rubber selected from the group consisting of butadiene rubber, butyl rubber, acrylonitrile-butadiene rubber, isoprene rubber and ethylene-propylene-diene rubber.

Confirming Matrix-domain Structure, Confirming Domain A, Confirming Centroid of Volume of Domain A, and Measuring Volume Resistivity of Core of Domain A

Confirmation of the matrix-domain structure, the domain A, the centroid of volume of the domain A, and the measurement of the volume resistivity of the core of the domain A are performed using FIB-SEM.

### Confirming Matrix-Domain Structure

The matrix-domain structure is confirmed as follows. The FIB-SEM is a method for processing a sample using a focused ion beam (FIB) apparatus, and observing an exposed cross section using a scanning electron microscope (SEM). To examine a three-dimensional structure, many images are obtained by repeating the processing and observing consecutively, then these SEM images are three-dimensionally reconstructed by computer-based software, so that the sample structure is constructed as a three-dimensional stereoscopic image.

To make observation easier, the pre-treatment is performed so that a contrast of the domain and matrix, and a contrast of the core and shell, are clearly obtained.

Specifically, osmium tetroxide, ruthenium tetroxide, phosphotungstic acid or the like can be used, and dyeing agents, to identify the second rubber and the third rubber respectively, can be appropriately selected. In the later mentioned examples, osmium tetroxide is used for dyeing. Since dyeing progresses more as the amounts of double bonds and benzene rings of the rubber are higher, the type of rubber is determined, and the domain, matrix, and the core and the shell can be distinguished thereby.

Sampling is performed from 12 locations of the conductive layer. When the length of the roller in the longitudinal direction is L, 3 locations (center of L, (¼) L from the center to each end, and (¼) on the left of the center) are determined, and at each of the three locations, one sample is cut out in the circumferential direction at 90° intervals.

The domain and matrix are distinguished by the above mentioned dyeing processing. In the case where a plurality of domains are dispersed in the matrix and the matrix has a communicating structure, it is determined that the matrix-domain structure is observed. Further, in the case where the matrix-domain structure is observed in at least 2 samples (preferably in at least 6, more preferably in at least 10), out of 12 samples, it is determined that the conductive layer has the matrix-domain structure.

### Confirming <Condition 1> and <Condition 2> for Domain A

Then the domain A is confirmed as follows. To confirm the domain A, samples are cut out as follows. When the length of the conductive layer in the longitudinal direction is L and the thickness of the conductive layer is T, a cross section of the conductive layer in the thickness direction (see FIG. 5B) is obtained at 3 locations (center of conductive layer in the longitudinal direction, and L/4 from each end of the conductive layer toward the center). Using a microtome (product name: Leica EMFCS, made by Leica Microsystems), a slice (about 2 μm) is cut out from the center position of the conductive roller in the longitudinal direction of the conductive layer, at a −100° C. cutting temperature.

In the sample which is cut out as above, the domain and matrix are distinguished, and the core and shell are distinguished according to the above mentioned procedure.

For each of the acquired cross sections, measurement is performed in a 15 μm square region at a 0.3T, 0.6T and 0.8T depths, in a 0.1T to 0.9T thickness region from the outer surface of the conductive layer toward the support member. Measurement positions are set at 3 points on each cross section (total of 9 points). At the total of 9 measurement points, <Condition 1> to <Condition 3> are confirmed as follows.

For <Condition 1> of the domain A, it can be easily determined whether the domain has the core-shell structure of which the core contains the second rubber and the electronic conductive agent, and the shell contains the third rubber, using the back scattered electron image of the image captured by the FIB-SEM.

For <Condition 2> of the domain A, the centroid of volume is calculated in the three-dimensional image obtained by the FIB-SEM, using the image analyzing apparatus (product name: LUZEX_AP, made by Nireco Corp., and it is analyzed whether the centroid of volume exists within the core of the domain.

### Confirming Centroid of Volume of Domain a and Measuring Volume Resistivity of Core of Domain A)

The centroid of volume of the domain A is confirmed and the volume resistivity of the core of the domain A is measured as follows.

First, every time the conductive layer is sectioned by the FIB-SEM and a plurality of cross sections are obtained, the volume resistivity is measured. Then the centroid of volume is specified in the three-dimensional image, whereby the measurement cross section, including the centroid of volume, is specified, and the volume resistivity of the measurement cross section, including the centroid of volume, is regarded as the volume resistivity of the core. The core, the shell and the matrix are distinguished based on the phase image of the domain cross section, and a rubber existing at the position of the centroid of volume is regarded as the second rubber.

Specifically, the conductive layer is sectioned by the FIB-SEM at 60 nm intervals, and every time a plurality of cross sections are obtained, the volume resistivity of the core of the domain A, existing in the cross section, is measured in the same manner as the method for measuring the volume resistivity of the matrix. Then the centroid of volume is calculated using the image analyzer (product name: LUZEX-AP, made by Nireco Corp.), whereby the measurement cross section including the centroid of volume is specified. Further, the volume resistivity of the centroid of volume portion of the core of the domain of this measurement cross section is measured in the same manner as the method for measuring the volume resistivity of the matrix. The same steps of forming cross sections and measuring the volume resistivity are repeated until the entire domain is sectioned.

If it is determined that the measurement target domain is the domain A based on the above mentioned criteria of <Condition 1> and <Condition 2>, the resistivity of a region which is within 100 nm radius around the centroid of volume, on the cross section closest to the centroid of volume of the domain, is regarded as the volume resistivity of the core of the domain A. An arithmetic mean of the volume resistivities obtained from the total 9 measurement positions is determined as the volume resistivity.

Further, the volume resistivity of the shell is measured according to the later mentioned <Measurement method for volume resistivity of the shell of domain A>, and then it is determined whether or not <Condition 3> is satisfied, based on this measurement and the result of measuring the volume resistivity of the core.

In the case where <Condition 1> to <Condition 3> are satisfied for at least 2 samples (preferable at least 6, more preferable at least 8), sliced from the total 9 points of measurement positions, it is determined that “a plurality of domains include a plurality of domains A”.

### Measurement Method for Ratio of Electronic Conductive Agent in Core of Domain A

The ratio of the cross sectional area of the electronic conductive agent contained in the core can be measured by binarizing the captured image mentioned above “confirming centroid of volume of domain A and measuring volume resistivity of core of domain A”, and quantizing the binary image. Based on the binary image, the cross sectional area S of the core and the total Sc of the cross sectional areas of portions of the electronic conductive agent in each core, are calculated by the image processing software Image-Pro Plus (made by Media Cybernetics). Then the arithmetic average (%) is calculated by (Sc/S)×100.

When the length of the conductive layer in the longitudinal direction is L and the thickness of the conductive layer is T, a cross section of the conductive layer in the thickness direction (see FIG. 5B) is obtained at 3 locations (center of L, and L/4 from the center to each end in the longitudinal direction of the conductive layer). For each of the obtained cross sections, a 15 μm² square region is disposed at 3 locations in the thickness region (0.1T to 0.9T) from the outer surface of the conductive layer toward the support member, then the above measurement is performed, and the arithmetic average of the measured values at the total 9 locations is calculated.

### Volume Resistivity of Shell

The volume resistivity of the shell of the domain A is more than 1.0×10¹² Ω·cm. In this range, the shell of the domain A can electrically insulate the core and the matrix of the domain A. As a result, a sufficient amount of charges can be easily stored in the domains without leaking the charges to the matrix. The volume resistivity of the shell is preferably 1.00×10¹³ Ω·cm or more, and is more preferably 8.00×10¹³ Ω·cm.

The upper limit of the volume resistivity of the shell is not especially limited, but may be 1.00×10¹² Ω·cm to 1.00×10¹⁹ Ω·cm or, from 1.00×10¹³ Ω·cm to 1.00×10¹⁸ Ω·cm or from 8.00×10¹³ Ω·cm to 1.00×10¹⁸ Ω·cm, for example.

The volume resistivity of the shell is determined by the composition of the shell. The shell contains a third rubber. For the third rubber, it is preferable to use a rubber having high volume resistivity in order to electrically insulate the core.

For example, a rubber that can be used for the third rubber is at least one rubber selected from a group of: natural rubber, butadiene rubber, butyl rubber, acrylonitrile-butadiene rubber, urethane rubber, silicon rubber, fluoro rubber, isoprene rubber, chloroprene rubber, styrene-butadiene rubber, ethylene-propylene rubber, ethylene-propylene-diene rubber, and polynorbornene rubber.

Particularly for the third rubber, it is preferable to use at least one rubber selected from a group of: natural rubber, butadiene rubber, butyl rubber, isoprene rubber, styrene-butadiene rubber and ethylene-propylene rubber, and it is more preferable to use at least one rubber selected from a group of: butadiene rubber, butyl rubber, isoprene rubber, styrene-butadiene rubber, and ethylene-propylene-diene rubber. If the third rubber is different from the second rubber, the phase separation between the core and the shell is easier, and the core-shell structure can be easily formed.

If necessary, the shell may contain fillers, processing aids, cross-linking agents, cross-linking aids, cross-linking accelerators, cross-linking acceleration aids, cross-linking retarders, antioxidants, softeners, dispersing agents or coloring agents. To set the volume resistivity of the shell to the above mentioned range, it is preferable that the shell does not contain such electronic conductive agents as carbon black.

### Measurement Method for Volume Resistivity of Shell of Domain A

To measure the volume resistivity of the shell, the above mentioned measurement method for the volume resistivity of the core may be performed in the same manner, changing only the measurement location to the location corresponding to the shell. An arithmetic mean of the volume resistivity obtained from the total 9 measurement locations is determined as the volume resistivity.

Concerning the ratio of the domains A that satisfy <Condition 1> to <Condition 3> mentioned above, the higher the ratio of the number of domains A, with respect to the total number of domains, the better. Specifically, the ratio of the number of domains A, with respect to the total number of domains, is preferably 23 number % or more, for example, more preferably 27 number % or more, more preferably 60 number % or more, and even more preferably 80 number % or more. The upper limit is not especially limited, but a preferable range of the ratio of the number of domains A, with respect to the total number of domains, may be 23 to 100 number %, or 27 to 100 number %, or from 60 to 95 number %, or 80 to 90 number %.

### Manufacturing Method for Domain A

In the case of increasing the ratio of the domain A, the electronic conductive agent is mixed with the second rubber using a pressure kneader to prepare a master batch. Also the first rubber and the third rubber are mixed to prepare a master batch. By mixing these master batches, a number of domains in the structure that will be domain A can be increased.

In the case where the domains constitutes a conductive layer having a matrix-domain structure, having the core-shell structure, it is preferable to select a rubber material such that the SP value of a rubber material forming the shell becomes a value between the SP values of the rubber materials forming the matrix and the core. It is more preferable if the SP value of the rubber material forming the shell is smaller than the SP value of the rubber material forming the matrix, and the SP value of the rubber material forming the shell is more than the SP value of the rubber material forming the core.

Rubbers having similar SP values have a high affinity with each other, therefore if the SP value of the rubber material forming the matrix, the SP value of the rubber material forming the shell, and the SP value of the rubber material forming the core having the above relationship, and the domain A can have the core-shell structure more easily. Specifically, it is preferable that the first rubber to be the matrix is acrylonitrile-butadiene rubber, the second rubber to be the core is styrene-butadiene rubber, and the third rubber is at least one rubber selected from a group of ethylene-propylene rubber, isoprene rubber and butadiene rubber. If these rubber materials are combined, the core-shell structure can be easily formed, and the ratio of the domains A to the domains can be increased more easily.

### Measurement Method for Ratio of Number of Domains a to Total Number of Domains

A ratio of a number of domains A to the total number of domains is determined by measuring three-dimensionally a conductive layer using FIB-SEM.

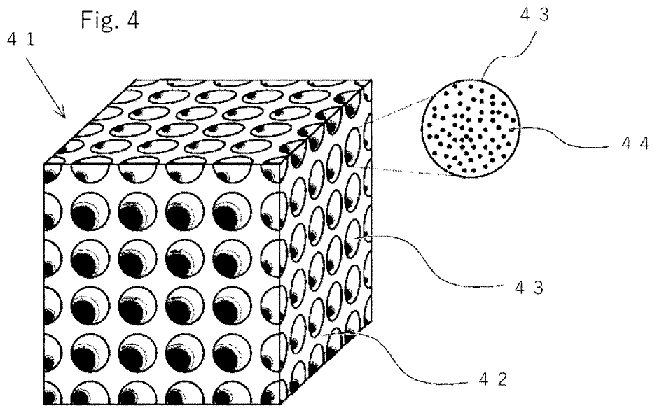

Specifically, the ratio of the domains A to the total number of domains is determined by obtaining a three-dimensional stereoscopic image, as indicated in FIG. 4, using FIB-SEM (made by FEI Co.), and confirming the above configuration in this image. In FIG. 4, 41 indicates a unit cube, 42 indicate a matrix, 43 indicates a domain, and 44 indicates a conductive particle.

Sampling is performed from 12 locations of the conductive layer. When the length of the roller in the longitudinal direction is L, 3 locations (center of L, (¼) L from the center to each end) are determined, and at each end of the 3 locations, one sample is cut out in the circumferential direction of the roller at 90° intervals.

Then the three-dimensional measurement is performed using FIB-SEM, so as to obtain a cross section at 60 nm intervals, and a cube-shaped image (unit cube 41), of which one side is 6 μm, is measured.

To appropriately observe the domain structure, dye treatment is performed in the same manner as the case of confirming the matrix-domain structure and confirming the domain A mentioned above, whereby the core, shell and matrix are distinguished.

The obtained image is then analyzed using 3D visualization and analysis software Avizo® (made by FEI Co.). Here the domains and matrix are binarized and image analysis is performed.

Then the total number of domains and the number of domains A included in one cubic-shaped sample (one side: 6 μm) are counted. The determination criteria for <Condition 1> and <Condition 2> of the target domain is the same as that of (Confirming domain A <Condition 1> and <Condition 2>) described above. The determination criteria for <Condition 3> is the same as that of (Confirming centroid of volume of domain A and measuring volume resistivity of core of domain A) described above. A domain that satisfies <Condition 1> to <Condition 3> is determined as a domain A. This processing is performed for 12 samples, and a ratio of a number of domains A, with respect to the total number of domains in all 12 samples, is calculated.

### Thickness of Shell

The thinner the thickness of the shell the better since the charge amount stored in the domain A increases, as indicated in the following Expression (1).

$$C = ε \frac{S}{d} \qquad ( 1 )$$

In Expression (1), d indicates the thickness of the shell, S indicates the surface area of the shell, C indicates the capacitance of the shell, and ε indicates the dielectric constant of the shell. As expressed in Expression (1), the capacitance C of the shell increases as d is smaller. This results in an increase in the charge amount stored in the domain A, which is preferable.

Specifically, the thickness of the shell is preferably 1.00 μm or less, is more preferably 0.70 μm or less, and is ideally 0.55 μm or less. However to suppress leaking charges to the matrix by isolating domains from each other with certainty by insulating regions, the thickness of the shell is preferably 0.10 μm or more, and is ideally 0.20 μm or more. In other words, the thickness of the shell may be, for example, 0.10 to 1.00 μm, 0.10 to 0.70 μm, or 0.20 to 0.55 μm.

### Measuring Method for Thickness of Shell

The measuring method for the thickness of the shell is the same as the measuring method for volume resistivity of the shell of the domain A, except that the thickness of the shell in each cross-section is measured instead of measuring the volume resistivity in each cross-section.

To make observation of the matrix-domain structure easier, a pre-treatment, to obtain a clear contrast of the core and the shell, is performed. Specifically, osmium tetroxide, ruthenium tetroxide, phosphotungstic acid or the like can be used, and dyeing agents to identify the second rubber and the third rubber respectively can be appropriately selected. In the later mentioned examples, osmium tetroxide is used for dyeing. Since dyeing processes more as the amounts of double bonds and benzene rings of the rubber are higher, the type of rubber is determined and the core and the shell are distinguished thereby.

The slice, after forming the fracture surface and performing pre-treatment, is observed by a scanning electron microscope (SEM) or a transmission electron microscope (TEM), and the presence of the matrix-domain structure is confirmed. For example, by observing at a 1000 times to 100000 time magnification using the SEM, quantification of the surface area of the domain becomes accurate.

The thickness of the shell is measured by quantifying the captured image of the fracture surface where the matrix-domain structure is captured. The image of the fracture surface obtained by observing with the SEM is converted into an 8-bit grayscale image using the image analyzing apparatus (product name: LUZEX-AP (made by Nireco Corp.)), whereby a 256 gradation monochrome image is obtained. Then the white and black of the image is inverted so that the shell on the fracture surface becomes white, and binarization processing is performed.

The thickness of the shell is calculated as the thickness of the thinnest portion of the shell forming one domain.

In the case of the cylindrical electrophotographic member, where the length of the conductive layer in the longitudinal direction is L and the thickness of the conductive layer is T, cross-sections in the thickness direction of the conductive layer, as indicated in FIG. 5B, are obtained at three locations (center of the conductive layer in the longitudinal direction, and locations at L/4 from both ends of the conductive layer toward the center). For each of the obtained cross-sections, an observation region of 15 μm square is disposed at three locations (0.2T, 0.5T and 0.7T) in the thickness region from the outer surface of the conductive layer toward the support member at a depth of 0.1T to 0.9T, and the thickness of each shell observed in the observation regions at the nine locations is measured.

The slice is cut out in a direction that allows observing the cross-section which includes a normal line starting from the rotation axis of the support member, since the surface, including the support member to the outer surface of the conductive layer (charge moving direction), needs to be observed.

### Requirement (3)

### Requirement (3-1)

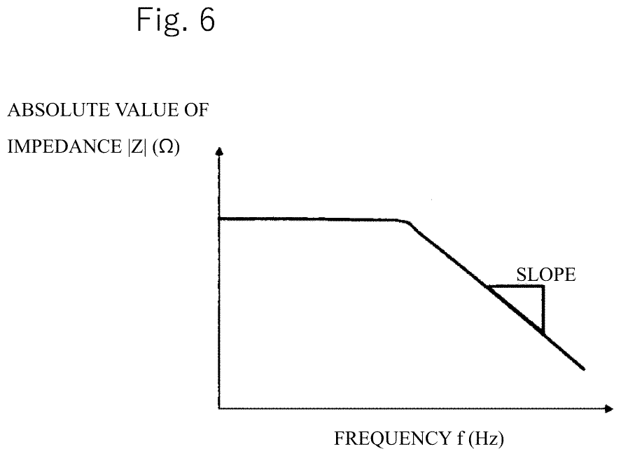

That fact that an slope in the frequency range of 1.0×10⁵ to 1.0×10⁶ Hz, when the frequency is plotted on an abscissa and the impedance is plotted on an ordinate in a log-log graph (hereafter also called “slope of impedance”), is −0.80 to −0.30, indicates that a stagnation of charges is not generated very much in the conductive roller on the high frequency side. If impedance of a conventional electrophotographic member such as conductive roller is measured and the absolute value of the impedance of the electrophotographic member is plotted on the ordinate and the frequency is plotted on the abscissa in the log-log graph, the slope always becomes −1 on the high frequency side. Here, as indicated in FIG. 6, the “slope” means the slope with respect to the abscissa when the absolute value of the impedance of the electrophotographic member is plotted on the ordinate and the frequency is plotted on the abscissa in the log-log graph. An equivalent circuit of the electrophotographic member is expressed by a parallel circuit of the electric resistance R and a capacitance C, and the absolute value |Z| of the impedance can be expressed by the following Expression (2).

Here “f” in Expression (2) indicates the frequency.

$$\vert Z \vert = \sqrt{\frac{1}{{R}^{- 2} + {( 2 π f )}^{2} {C}^{2}}} \qquad ( 2 )$$

The reason why the high frequency side becomes a line in which the slope is −1 is probably as follows. If the movement of charges cannot follow the high frequency voltage, the charges stagnate. Therefore, it can be inferred that the state where the electric resistance R is increased to be very high, in other words, the insulated capacitance is measured. The state where charges stagnate is assumed to be a state where R is approximated to infinity, in Expression (2). Here in Expression (3), which is the expression when the element of the denominator in Expression (2) is extracted, R⁻² can be approximated to be a very small value with respect to (2πf)²C². Therefore Expression (2) can be transformed to Expression (4) generated by removing R⁻² based on the approximation. Finally Expression (4) is transformed so that both sides become logarithms, whereby Expression (5) is established, and the slope of log f becomes −1.

$${R}^{- 2} + {( 2 π f )}^{2} {C}^{2} \qquad ( 3 )$$

$$\vert Z \vert = \frac{1}{{( 2 ω f )}^{2} {C}^{2}} \qquad ( 4 )$$

$$log \vert Z \vert = - log f - log ( 2 π C ) \qquad ( 5 )$$

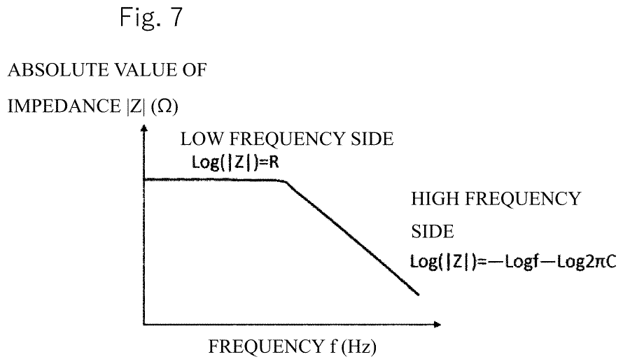

The meaning of Expressions (2) to (5) will be described with reference to FIG. 7. In FIG. 7, the ordinate indicates a logarithm of the absolute value of the impedance, and the abscissa indicates a logarithm of the frequency of the measured oscillating voltage. FIG. 7 indicates a behavior of impedance expressed by Expression (2). As described above, the impedance that satisfies Expression (2) drops at a certain frequency as the frequency increases. This dropping behavior, in the log-log plot in FIG. 7, generates a line of which slope is −1, without the slope depending on the electric resistance value and the capacitance of the electronic photographic member, as expressed in Expression (5).

When the impedance characteristic of the electrophotographic member having insulating properties is measured, the line, of which slope is −1, is generated, hence it is presumed that the state of generating a line, of which slope is −1 in the measurement for impedance of the electrophotographic member, indicates the state where the characteristic that the movement of charges stagnates on the high frequency side is expressed. If the movement of charges stagnates on the high frequency side, the supply of charges for discharge cannot follow the frequency of discharge. As a result, it is assumed that a timing at which discharging is disabled is generated, and the discharge is leaking.

On the other hand, in the conductive roller whose the slope of impedance is −0.80 to −0.30 in the high frequency region of 1.0×10⁵ to 1.0×10⁶ Hz, the supply of charges is less likely to stagnate on the high frequency side. In this case, charges can be supplied when discharge is generated on the high frequency side where charges tend to stagnate easily. Since charges can be supplied smoothly, the leaking of discharge can be suppressed, and the total amount of the discharge can be improved. This range of the high frequency region seems to be a region where the leaking of discharge is easily generated, probably because this is a region where the frequency is highest among the frequencies of discharge generated from the conductive roller. If the slope is in the above mentioned range, which is larger than −1, in this frequency region, an slope larger than −1 can be obtained even in the high frequency region that is lower than this frequency region, and the generation of leaking of discharge can be suppressed, and the total amount of discharge can be improved.

If the slope of impedance is less than −0.80, leaking of discharge is generated, and a drum ghost is more easily generated.

The slope of impedance in a region where the frequency is 1.0×10⁵ to 1.0×10⁶ Hz is preferably −0.72 to −0.35, and more preferably −0.55 to −0.35.

The inventors think that the frequency of discharge in a case of using the combination of the charging roller as the conductive roller and the photosensitive drum will be in the following range.

A discharge region in the moving direction of the surface of the charging roller, which is disposed to face the outer surface of the photosensitive drum and rotates synchronizing with the photosensitive drum, is set to 0.5 mm to 1 mm. If the process speed of the electrophotographic apparatus is 100 to 500 mm/sec at the maximum, then the time for the surface of the photosensitive drum to pass the discharge region is 10⁻³ sec to 10⁻² sec or more. In a detailed observation of discharge, the length of the discharge region by a single discharge is 0.01 mm to 0.1 mm, hence it is presumed that discharge is generated at least 5 to 100 times, while a certain point on the surface of the charging roller passes the discharge region. Therefore the frequency of the discharge generated by the charging roller is estimated to be in a several Hz to 1.0×10⁶ Hz range. As the process becomes faster, the frequency of discharge must be increased so as to increase a number of times of discharge, hence even in the above range, control of discharge and the conductive mechanism, particularly in the 1.0×10⁵ Hz to 1.0×10⁶ Hz high frequency region, is critical.

As mentioned above, in order to increase the number of times of discharge, it is effective to make the slope of the impedance in the high frequency region to deviate from −1. This can allow for better achievement of the characteristics in which the discharge and the supply of charges for the next discharge are quickly done. Deviation of the slope of the impedance from −1 means that the supply of charges in the conductive roller is not stagnated, hence this conductive roller can implement characteristics to suppress the leaking of discharge.

### Requirement (3-2)

The fact that the impedance (hereafter also called “low frequency impedance”) in the frequency range of 1.0×10⁻² to 1.0×10¹ Hz is 1.00×10³ to 1.00×10⁷Ω indicates that the stagnation of charges is less likely to occur on the low frequency side. As mentioned above, the absolute value |Z| of the impedance can be expressed by the above Expression (2). In Expression (2), if the frequency is approximated to zero, the absolute value of the impedance is approximated to the electric resistance R, and the electric resistance R indicates the electric resistance when charges move in a single direction. Therefore measuring the impedance while applying a low frequency voltage is probably like simulating an impedance based on the moving amount of the charges in the state where the movement of the charges can follow the oscillation of the voltage.

In other words, the low frequency impedance is an index of how easily charges move between the conductive roller and the measurement electrode, and is also an index of the charge amount that can be moved by discharge from the surface of the conductive roller to the photosensitive drum.

The amplitude of the AC voltage used for measuring impedance according to Requirement (3-1) and Requirement (3-2) is 1V. This AC voltage for measurement is much lower than the voltage actually applied to the conductive roller in the electrophotographic image forming apparatus (which is several hundred to several thousand V). Therefore by measuring the impedance according to Requirement (3-1) and Requirement (3-2), the ease of discharge generated from the surface of the conductive roller can be evaluated at a high dimension.

Further, by satisfying Requirement (3-2), the ease of discharge can be controlled to an appropriate range. If the impedance is lower than 1.00×10³Ω, the amount of one discharge step becomes too large, and the supply of charges for the next discharge step cannot keep pace. As a result, the leaking of discharge tends to occur, which makes it difficult to suppress ghost images. If the impedance exceeds 1.00×10⁷Ω, on the other hand, the ease of discharge drops, and the discharge amount does not reach the level required for filling the surface potential unevenness.

The low frequency impedance is preferably 2.00×10³ to 1.00×10⁶Ω, and is preferably 2.00×10³ to 1.00×10⁵Ω.

As described in FIG. 7, in the electrophotographic member, the absolute value of impedance becomes a constant value in the low frequency region. Therefore the impedance in the 1.0×10⁻² to 1.0×10¹ Hz range can be substituted with a value of impedance at 1 Hz frequency, for example.

The conductive roller that satisfies both Requirement (3-1) and Requirement (3-2) can obtain a discharge amount at a level of eliminating the unevenness of the surface potential of the photosensitive drum, and suppressing the ghost images in the frequency regions from the low frequency side to the high frequency side. Furthermore, by satisfying Requirement (3-1), the leaking of discharge on the high frequency side can be suppressed. By satisfying Requirement (3-2), the discharge performance is further improved, and the generation of ghost images can be effectively suppressed.

By forming the matrix-domain structure, Requirement (3-1) or Requirement (3-2) can be satisfied. If the domains include a plurality of domains A, Requirement (3-1) and Requirement (3-2) can be simultaneously satisfied. A manufacturing method of the matrix-domain structure and a preferable method for manufacturing the domains A in the matrix-domain structure will be described later.

### Measuring Method for Impedance

Impedance can be measured by the following method. When impedance is measured, the influence of contact resistance between the electrophotographic member and the measurement electrode must be eliminated. Therefore a low resistance thin film is deposited on the surface of the electrophotographic member, and this thin film is used as an electrode. On the other hand, a conductive support member is used as a ground electrode, and impedance is measured using these two terminals.

To form the thin film, an electrode forming method, such as metal deposition, splattering, metal paste coating, and attaching a metal tape, can be used. In the present disclosure, a platinum thin film is deposited as a platinum electrode, in order to decrease the contact resistance with the electrophotographic member.

In the case where the cross section is roller-shaped, such as the case of the conductive roller, it is preferable to use a vacuum deposition apparatus to which a rotation mechanism is attached. Further, in the case of the cross section being roller-shaped, it is preferable to use the following method, since connection of the platinum electrode (measurement electrode) and the impedance measuring apparatus is difficult.

Specifically, after forming a platinum electrode (10 mm to 20 mm width) in the longitudinal direction of the roller, a metal sheet is wound around it without a gap, and this metal sheet and the measurement electrode, exposed from the measuring apparatus, are connected, and impedance is measured. Thereby electric signals from the conductive layer of the electrophotographic member can be smoothly acquired by the measuring apparatus, and impedance measurement can be performed. The metal sheet may be made of any metal of which electric resistance value is similar to the metal portion of the connection cable of the measuring apparatus when impedance is measured, and aluminum foil, metal tape or the like can be used.

The impedance measuring apparatus may be any apparatus that can measure impedance up to the 1.0×10⁷ Hz frequency region, such as an impedance analyzer, a network analyzer, and a spectrum analyzer. In terms of the electric resistance range of the electrophotographic member, measurement by the impedance analyzer is preferable.

The impedance measurement conditions will be described. Using the impedance measuring apparatus, impedance in the frequency region of 1.0×10⁻² to 1.0×10⁷ Hz is measured. Measurement is performed under an environment of a 23° C. temperature and a 50% relative humidity. To decrease measurement dispersion, five measuring points are set for each digit of frequency. The positions of the five measuring points are selected at equal intervals, for example, so as not to be arbitrary. In the case where the electrophotographic member can be equally divided into five parts, a measuring point is disposed at the center portion of each of the five divided regions, although this may depend on the shape of the electrophotographic member. The amplitude of the AC voltage is 1V.

The measurement voltage may be measured while applying DC voltage while considering the sharing voltage applied to the electrophotographic member inside the electrophotographic apparatus. Particularly, measurement while superimposing a DC voltage of 10 V or less with an AC voltage is preferable for quantifying the characteristics of transporting and storing charges.

A method for calculating the slope of impedance will be described next. For the result of measurement under the above mentioned conditions, the absolute value of impedance is plotted with respect to the measuring frequency in the log-log graph, using spreadsheet software (e.g. “Microsoft Excel (product name)” (made by Microsoft Corp.). In the graph obtained by this log-log plot, the slope of impedance in the 1.0×10⁵ to 1.0×10⁶ Hz frequency region is determined using the measuring points in the 1.0×10⁵ to 1.0×10⁶ Hz frequency region.

Specifically, in the plot in this frequency range, an approximate line of the linear function is calculated by the least square method, and the slope of the determined approximate line is calculated. Then the arithmetic average value of the values at the measuring points in the 1.0×10⁻² to 1.0×10¹ Hz frequency region in this log-log graph is calculated, and the obtained value is regarded as the impedance on the low frequency side.

To measure the slope of impedance in the conductive roller, an arithmetic average of slope measured at 3 locations is calculated. The 3 locations are: when the length of the conductive layer of the roller in the longitudinal direction is L, the center of L, and L/4 from each end toward the center.

### Requirement (4)

The outer surface of the conductive layer is constituted of a portion M originated from the matrix, and portion D originated from the domains. When the length of the conductive layer in the longitudinal direction is L, at 12 locations in total of the center of L and L/4 from each end toward the center at 90° intervals, a 100 μm square observation region is disposed on the outer surface of the conductive layer in the circumferential direction of the conductive layer, such that one side of the square is parallel with the circumferential direction of the conductive roller. In this state, the following Requirements (4-1) and (4-2) are satisfied.

### Requirement (4-1)

When an area R1 is an area where the portion M occupies the observation region, and an area R2 is an area 2 where the portion D occupies the observation area, the ratio thereof (R2/R1) is 0.50 or more. In other words, the portion D, which is the conductive component, occupies a larger area, and the charges which reached the outer surface of the conductive layer can move relatively freely. Thereby the surface charge amount of the conductive roller changes in accordance with the potential unevenness of the photosensitive drum.

In order to further increase the degree of freedom of charge mobility in the conductive portion D, it is preferable that the portion D and portion M has a matrix-domain structure. The ratio of R2 (that is, R2/R1) is preferably 0.70 or more. The upper limit is not especially limited, but 0.90 or less is preferable. R2/R1 is 0.50 to 0.90, for example, and is preferably 0.70 to 0.90.

On the surface of the conductive roller, components other than the portion M and portion D may exist within a range not influencing the degree of freedom of the charge mobility. Specifically, a 20% or less area of components other than the portion M and portion D may exist.

The portion M which originated from the matrix is a portion constituted of the first rubber, for example, that is, a portion constituted of a material of the matrix. The portion D which originated from the domains is a portion constituted of the second rubber and the electronic conductive agent, and a portion constituted of the third rubber, for example, that is, a portion constituted of materials of the core and the shell.

### Requirement (4-2):

99 lines are drawn in the observation region, along the rotation shaft of the conductive roller, at 1 μm intervals in the circumferential direction of the conductive roller, a plurality of lines out of the 99 lines cross the portion M. Then, in a line that crosses portion M, the part that overlaps with portion M is defined as a line segment LS. Here the ratio of the number of line segments LS, of which length is 20 μm or more, is 5% or less, with respect to the total number of line segments LS.

The ratio of 5% or less indicates that the conductive portion D in the rotation shaft direction of the conductive roller is divided in parts by an insulating portion M. This can prevent transverse discharge, that is, a strong discharge spreading in the longitudinal direction of the conductive roller, making the potential higher than a desired value. In other words, the presence of an insulating portion M prevents the discharge from spreading, just as it divides the conductive portion D.

As described above, the conductive roller of the present disclosure can quickly change the surface charge amount responding to the major potential unevenness of the photosensitive drum. In other words, an appropriate discharge can be performed regardless the potential unevenness of the photosensitive drum, whereby uniform charging can be implemented.

The ratio of the number of line segments LS of which length is 20 μm or more, with respect to the total number of line segments LS, is 5% or less, and is preferably 4% or less, and is more preferably 3% or less. The ratio of the number of line segments LS of which length is 20 μm or more, with respect to the total number of line segments LS, is 0 to 5%, for example, is preferably 1 to 5%, is more preferably 1 to 4%, and is even more preferably 2 to 3%.

The ratio of the number of lines crossing the portion M, with respect to the 99 lines, is preferably 10% or more, and is more preferably 20% or more. The ratio of the number of liens crossing the portion M, with respect to the 99 lines, is 8 to 82%, for example, is preferably 10 to 80%, and is even more preferably 20 to 80%.

### Observing Surface Structure for Requirements (4-1) and (4-2)

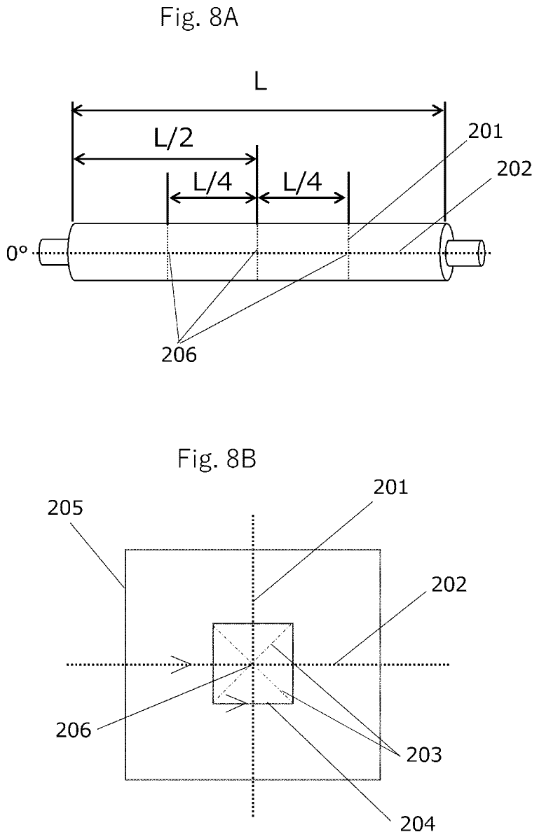

From the conductive layer of the conductive roller, samples for observation, including the outer surface of the conductive layer, are cut out. FIG. 8A indicates a part of the positions where samples were cut out. When the length of the conductive layer in the longitudinal direction is L, at the total 12 locations of the center of L and L/4 toward each end from the center at 90° intervals in the circumferential direction, a marking 206 is formed at the intersection between the line 201 in the longitudinal direction and the line 202 in the circumferential direction, and a 2 mm sample 205 is cut out such that the marking portion is included at the center.

To observe the SEM well, pre-treatment is performed so that the clear contrast of the matrix and the domains (core and shell) can be obtained. Specifically, osmium tetroxide is used for dying.

After platinum is deposited on the outer surface of each obtained sample, an image of the platinum deposited source is captured using a scanning electron microscope (SEM) (product name: S-4800, made by Hitachi High Tech Corp.) at 1,000 magnification, so as to obtain an SEM image of the outer surface.

Then the captured image is quantized. Here on this image of the outer surface of the conductive layer obtained by observation using SEM, 8-bit grayscale processing is performed using image processing software (product name: Image-Pro Plus, made by Media Cybernetics Co.), whereby a 256 gradation monochrome image is obtained. Then the black and white of the image is inverted so that the portion D which originated from the domains containing the core and shell of the outer surface of the conductive layer (that is, the position of the second rubber and the electronic conductive agent, and the portion of the third rubber) becomes white, whereby the binary image is obtained.

From the obtained binary image, a square 204, of which one side is 100 μm, is cut out. FIG. 8B indicates details on the cut out position. A square observation region is set in the sample 205, such that a diagonal line 203 of the square 204 passes through a marking 206, and one side of the square becomes parallel with a line 202 at a position in the circumferential direction. At this setting position, an area R1 of the portion M and an area R2 of the portion D are determined, and the area ratio R2/R1 is calculated. Here the same operation is performed for the 12 locations, and the arithmetic average thereof is regarded as the final area ratio R2/R1.

Further, in each of the 12 100 μm square observation regions, 99 lines are drawn along the rotation shaft of the conductive roller, at 1 μm intervals in the circumferential direction of the conductive roller. Here the plurality of lines overlap with the portion M, out of the lines crossing the portion M, are regarded as the line segments LS. With respect to the total number of the line segments LS, the ratio of the number of line segments LS, of which length is 20 μm or more, is calculated. The same operation is performed for the 12 locations, and the arithmetic average thereof is regarded as the ratio of the number of line segments LS. The ratio of the number of lines crossing the portion M, with respect to the 99 lines, is also calculated.

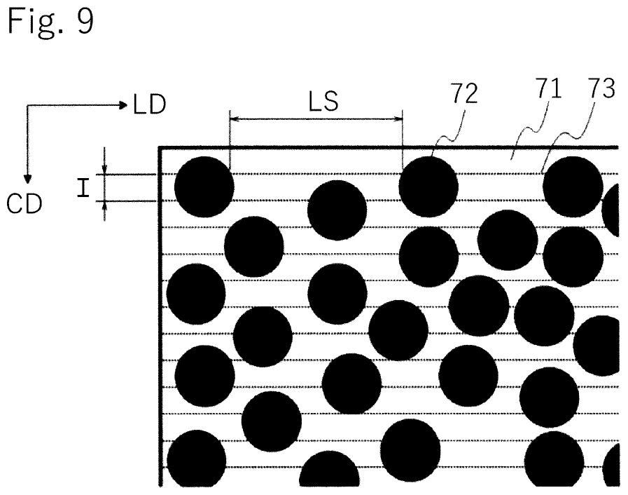

FIG. 9 is a diagram for describing calculation of the ratio of the number of line segments LS. On the surface of the roller, dotted lines are drawn in the longitudinal direction LD, at intervals I (=1 μm) in the circumferential direction CD. The black dots indicate the portion D which originated from the domain. The line segment in the insulating portion M between black dots is regarded as LS, and the ratio of the number of line segments LS is calculated by counting the length of the line segments and a number of the line segments.

The manufacturing method for the conductive roller that satisfies Requirements (4-1) and (4-2) will be described later in <Manufacturing method for conductive roller>.

### Requirement (5):

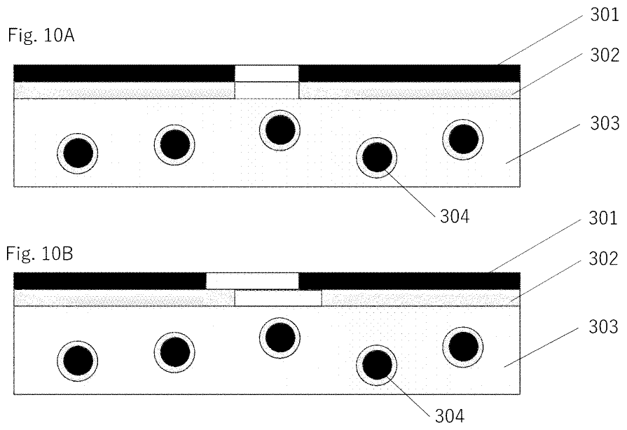

FIG. 10A indicates the state of Requirement (5). In the cross section of the conductive layer in the thickness direction, the portion containing the second rubber and the electronic conductive agent, out of the portion D on the outer surface of the conductive layer, is regarded as a portion C (portion C is indicated by 301 in FIGS. 10A and 10B). In other words, the portion C is a component of the core. Here a portion E (302 in FIGS. 10A and 10B) containing the third rubber exists directly under the portion C. For example, the portion E, which is a shell component, exists directly under the component constituting the core which is a conductive portion. 303 indicates a portion of the matrix, and 304 indicates each domain existing inside the conductive layer.

Because the portion E exists directly under the core of the conductive layer, excessive discharge can be cut off, which prevents the generation of abnormal discharge, and makes it easier to suppress white spot images and the generation of transverse current. In the portion C, the second rubber and the electronic conductive agent are dominant, for example.

For the portion E to exist directly under the portion C on the surface of the conductive layer, it is preferable that the SP values of the rubbers used for the matrix, the core and the shell satisfy the relationship of matrix>shell>core. In this case, when the portion D, containing the rubber of the core, is exposed to the surface, affinity with the rubber of the shell becomes high, because the SP values are close. Hence the rubber of the shell is attracted to the rubber of the core, and moves directly under the core. However components other than the portion E, such as the components of portion M, may exist directly under the portion D, as indicated in FIG. 10B, as long as the effect of suppressing the generation of abnormal discharge can be obtained. Further, the portion E may exist directly under the portion M.

In terms of improving the performance to prevent abnormal discharge and suppressing white spot images, the ratio of the portion E, existing directly under the portion C, with respect to the number of portions C, is preferably 30% or more, more preferably 50% or more, more preferably 75% or more, and even more preferably 80% or more. The higher the ratio of existence of the portion E the better, and the upper limit is not especially limited. The ratio of the portion E existing directly under the portion C, with respect to the number of portions C, is preferably 30 to 100%, more preferably 50 to 100%, more preferably 75 to 95%, and even more preferably 80 to 90%.

### Measurement Method for Portion E

A slice, after a fractured surface is formed and pre-treatment is performed, is observed using a scanning electron microscope (SEM) at 1000 to 100000 magnification.

When the length of the conductive layer in the longitudinal direction is L, as indicated in FIG. 5B, 3 locations, i.e., the center of L and L/4 from each end toward the center, or the total 12 locations thereof at 90° intervals in the circumferential direction are determined. Then the cross sections of the conductive layer in the thickness direction, as indicated in FIG. 5B, are obtained from the total 12 locations. For each of the obtained cross sections, a 30 μm square observation region is set, and the ratio of the portion E, existing directly under the portion C, is measured for each all 12 observation regions.

The portion C and the portion E are measured by quantizing the captured images of the fractured surface. For the image of the fractured surface obtained using the SEM, 8-bit grayscale processing is performed using an image processing analyzing apparatus (product name: LUZEX-AP, made by Nireco Corp.), and a monochrome image with 256 gradations is obtained.

For the measurement, a pre-treatment to obtain a clear contrast of the core, the shell and the matrix, is performed. Here dyeing processing is appropriate. Specifically, osmium tetroxide, ruthenium tetroxide, phosphotungstic acid, and the like can be used, and dyeing agents, to identify the first rubber and the second rubber respectively, can be appropriately selected. In the later mentioned examples, osmium tetroxide is used for dyeing. Since the dyeing progresses more as the amounts of double bonds and benzene rings are higher, the type of the rubber is determined, and the core, the shell and the matrix are distinguished thereby.

Then the obtained image is analyzed using 3D visualization and analysis software Avizo® (made by FEI, Co.).

Then in the 30 μm square region, a ratio of the portion E, which exists directly under the portion C existing on the arc of the outer surface of the roller, with respect to the number of portions C, is analyzed. If the third rubber of which thickness is 10 nm or more exists in the thickness direction of the roller, this portion is determined as the portion E. This step is performed for 12 samples, and the arithmetic average is regarded as the ratio of the portion E existing directly under the portion C.

If the ratio of the portion E existing directly under the portion C is 25% or more, with respect to the number of portions C, it is determined that “the portion E containing the third rubber exists directly under the portion C in the conductive layer”.

The manufacturing method for the conductive roller that satisfies Requirement (5) will be described later in <Manufacturing method for conductive roller>.

### Manufacturing Method for Conductive Roller

An example of the manufacturing method for the conductive roller will be described below. The manufacturing method for the conductive roller in this example includes the following steps (i) to (iv), but the present invention is not limited thereto, as long as the configuration described in the present disclosure can be implemented.

The conductive roller according to the present disclosure can be manufactured by the following steps (i) to (iv).
Step (i): a step of preparing a rubber composition for forming the core (hereafter also called “CMB”) containing an electronic conductive agent (e.g. carbon black) and the second rubber;
Step (ii): a step of preparing a rubber composition for forming the matrix and the shell (hereafter also called “MSC”) containing the first rubber and the third rubber;
Step (iii): a step of kneading CMB and MSC to prepare a rubber composition for forming the conductive layer which has the matrix-domain structure of which domain has the core-shell structure;
Step (iv): a step of forming the layer of the rubber composition for forming the conductive layer on the support member directly or via another layer, and curing the layer of the rubber composition to form the conductive layer.

If necessary, the conductive layer may be adhered to the support member using an adhesive. The conductive layer formed on the support member may also be vulcanized if necessary, and such a surface treatment as UV treatment may be performed thereon after polishing. In the case of performing vulcanization, a vulcanizing agent may be added to the rubber composition for forming the conductive layer in Step (iv). Then the vulcanization may be performed in the above mentioned curing step. The vulcanization agent is not especially limited, and may be sulfur, for example.

The conductive roller according to the present disclosure has a matrix-domain structure in the cross section of the conductive layer in the thickness direction, where the domains constituted of the core (second rubber) and the shell (third rubber) are dispersed in the matrix (first rubber). The outer surface of the conductive roller is constituted of at least the portion M which originated from the matrix component and the portion D which originated from the domain component, and the area R2 of the portion D is larger than the area R1 of the portion M on the outer surface. In the cross section of the roller, the portion E containing the third rubber exists directly under the portion C which is the core component. The present inventors found that the manufacturing method, including the above Steps (i) to (iv), is most appropriate to obtain a conductive roller having the surface structure and cross-sectional structure mentioned above.

### Manufacturing Method for Forming Matrix-Domain Structure and Core-Shell Structure

The amount of the second rubber, with respect to 100 parts by mass of the first rubber is preferably 13 to 100 parts by mass, and is more preferably 5 to 50 parts by mass. The amount of the third rubber, with respect to 100 parts by mass of the first rubber, is preferably 10 to 100 parts by mass, more preferably 10 to 30 parts by mass, and even more preferably 20 to 30 parts by mass.

If two or more types of incompatible rubbers are mixed, phase separation is normally generated. This is because the interaction between the same polymers is stronger than the interaction between different polymers, and the same polymers tend to aggregate, which drops the free energy to stabilize the state.

The interface of the phase separation structure contacts with different polymers, hence free energy becomes higher than inside the structure, which is stabilized by interactions between the same molecules. As a result, interfacial tension is generated, attempting to decrease the area contacting with different polymers, so as to decrease the free energy at the interface. If this interfacial tension is small, even different polymers are directed to be mixed uniformly so as to increase entropy. The uniformly mixed state indicates dissolution, and the SP value (solubility parameter), which is the index of solubility, tends to correlate with the interfacial tension. In other words, the interfacial tension difference between CMB and MSC may correlate with the SP value difference of the rubbers contained in CMB and MSC.

It is known that in the case of mixing three or more types of incompatible rubber materials, the dispersion states will vary depending on the SP values of the rubber materials that are mixed.

In the case of forming the conductive layer which has the matrix-domain structure where the domain has the core-shell structure, it is preferable to select rubber materials so that the SP value of the rubber material forming the shell has an intermediate value between the SP values of the rubber materials forming the matrix and the core, and it is preferable that the SP value of the rubber material forming the shell is smaller than the SP value of the rubber material forming the matrix, and the SP value of the rubber material forming the shell exceeds the SP value of the rubber material forming the core. Rubbers having similar SP values have high affinity, hence if the SP value of the rubber material forming the matrix, the SP value of the rubber material forming the shell, and the SP value of the rubber material forming the core have the above mentioned relationship, the domain A can more easily have the core-shell structure.

The difference between the absolute values of the solubility parameters of each rubber material is preferably 0.4 to 5.0 (J/cm³)^{0.5}, and is more preferably 0.4 to 2.2 (J/cm³)^{0.5}. If in this range, the matrix-domain structure of which domain has the core-shell structure can be easily formed.

The thickness of the conductive layer is not especially limited, as long as the target functions and effects of the conductive roller can be obtained. The thickness of the conductive roller is preferably from 1.0 mm to 4.5 mm.

### Measurement Method for SP Value

The SP value can be accurately calculated by generating a calibration curve using a material of which SP value is already known. For this SP value, a catalog value of a material manufacturer may be used. For example, the SP values of NBR and SBR are virtually determined by the content ratios of acrylonitrile and styrene, without depending on the molecular weight.

Therefore the content ratio of acrylonitrile or styrene of the rubbers constituting the matrix and the domain are analyzed using such an analysis method as pyrolysis gas-chromatography (Py-GC) or solid-state NMR. Then the SP values can be calculated using the calibration curve obtained from a material of which SP value is known.

The SP value of isoprene rubber can be determined using an isomer structure, such as 1,2-polyisoprene, 1,3-polyisoprene, 3,4-polyisoprene, cis-1,4-polyisoprene and trans-1,4-polyisoprene. Hence just like the case of SBR and NBR, the isomer content ratio is analyzed using Py-GC, solid-state NMR or the like, and the SP value can be calculated based on a material of which SP value is known. The SP value of the material of which SP value is known has been determined by the Hansen solubility sphere method.

### Charge Attenuation Rate

The charge attenuation rate of the conductive roller is not especially limited, but is preferably 50 to 95%, and is more preferably 65 to 95%. In this range, the charges, which are charged up due to adhering contaminating substances to the conductive roller, can be moved toward the support member side more easily. The charge attenuation rate can be decreased by increasing the volume resistivity of the matrix, and can be increased by decreasing the volume resistivity of the matrix, for example.

### Calculation Method for Charge Attenuation Rate

The charge attenuation rate can be calculated by measuring the surface potential of the charged surface of the conductive roller. For example, voltage is applied to a corona discharger to discharge electricity, and the surface of the conductive roller is charged thereby. Then the surface potential of the charging roller immediately after charge (immediately after discharge ended) and the surface potential of the charged roller 10 seconds later are measured. Based on the change between the surface potential immediately after the discharge and the surface potential 10 seconds later, the charge attenuation rate can be calculated. A specific method thereof will be described later.

Manufacturing Method to Implement Surface Structure and Structure Directly under Surface

The Step (iv) is a step of forming the layer constituted of a rubber composition for forming the conductive layer on the support member directly or via another layer, curing this layer of the rubber composition and forming the conductive layer thereby. It is preferable to form the layer constituted of the rubber composition for forming the conductive layer by extrusion molding. For example, a cross head extruder may be used. The step of forming the layer constituted of the rubber composition for forming the conductive layer is preferably a step of forming a conductive roller by integrating the conductive support member and the conductive layer using the cross head extruder. It is also possible to form a structure in which the matrix and the domain are reversed by aggregating the rubber composition to the outer surface of the domain. To manufacture the conductive layer, extrusion molding is commonly used. The conductive layer is preferably an extrusion molded body.

The outer surface of the conductive layer can be adjusted by the flow rate of rubber, the speed of the supporting member, and the relationship of the dye of the extruder and the outer diameter of the extrusion. The flow in the tube of the extrusion roller is fast in the center region, and becomes slower on the wall face side because of friction. Therefore substances which have high viscosity and low fluidity move to the wall face side. In other words, the cores containing carbon in the domains have high viscosity, and tend to move to the wall face side in the tube, that is, to the outer surface of the roller. The outer surface of the conductive layer may have a structure in which the matrix and the domains are reversed.

In the case of the extrusion molding, a large sheer force is applied to the outermost surface of the conductive layer, since the material of the conductive layer is coated using tubular dye. In other words, the sheer force is applied to the outermost surface of the conductive layer in a non-depth direction, hence the outermost layer is stretched in the non-depth direction. Further, pressure, which has been applied to the conductive layer material by the extender, is released when the compressed conductive layer material is pushed out of the extrusion port, and the extruded conductive layer material expands in the thickness direction (dye swell). At this time, the domains of the conductive layer material move toward the outer surface.

The core components of the domains move to the surface of the roller in this way, and as the core components move, the shell components are formed directly under the core components. Therefore the relationship of R2>R1 can be easily implemented, by increasing the amount of carbon black of CMB, or by increasing the viscosity of the rubber (e.g. Mooney viscosity) used for the CMB, so as to increase R2. Further, the more portions D corresponding to the domains that exist on the surface of the conductive layer, the easier it is to make the ratio of the number of line segments LS to 5% or less. Furthermore, by integrating the preferable relationship of the SP values mentioned above, the portion E can more easily exist directly under the portion C where the core exists.

It is also effective to aggregate domains on the outermost surface by decreasing the inner diameter of the dye or by increasing the flow rate of the rubber, for example, so as to apply a larger sheer force. If the inner diameter of the dye is decreased, the outer surface of the conductive roller is stretched by a larger force, and the matrix and the domain, existing at a certain depth from the outer surface, expand. In other words, as the inner diameter of the dye is decreased, more domains are stretched, and a number of expanded domains increases. If the flow rate of the rubber is increased, the difference of the flow rates between the center and the wall face in the extrusion tube increases, and the core components having high viscosity move to the wall face more easily.

As a result, the relationship of the area R1 of the portion M which originated from the matrix component and the area R2 of the portion D which originated from the domain component becomes R2>R1 on the outer surface of the conductive layer, while this is R1>R2 inside the conductive layer. This effect is also influenced by the viscosity of the unvulcanized rubber composition used for the extrusion molding, so adjustment may be performed for each rubber composition. If R2>R1 is satisfied on the outer surface like this, the cross sections become as in FIGS. 10A and 10B.

### Process Cartridge

The present disclosure provides a process cartridge detachably attached to a main body of an electrophotographic image forming apparatus, wherein the process cartridge comprises: an electrophotographic photosensitive member, and a charging member arranged so as to be capable of charging the electrophotographic photosensitive member, and the charging member is the conductive roller of the present disclosure.

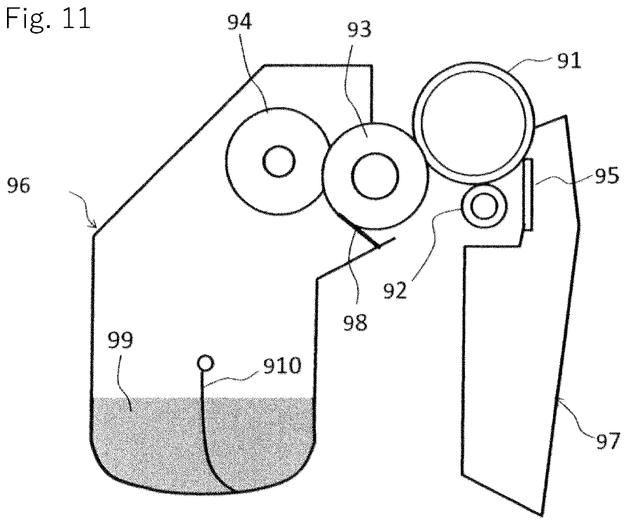

FIG. 11 is a schematic cross-sectional view of the process cartridge for electro photographs, which includes the conductive roller according to the present disclosure as the charging roller. This process cartridge is an integration of a developing apparatus and a charging apparatus, and is detachably attached to the main body of the electrophotographic apparatus. The developing apparatus is an integration of at least a developing roller 93 and a toner container 96, and may also include a toner supply roller 94, toner 99, a developing blade 98 and a stirring blade 910 if necessary.

The charging apparatus is an integration of at least a photosensitive drum 91, a cleaning blade 95 and a charging roller 92, and may also include a waste toner container 97. Voltage is applied to the charging roller 92, the developing roller 93, the toner supply roller 94 and the developing blade 98 respectively.

The conductive roller according to the present disclosure may be used as a charging roller, a developing roller, a developing blade and a toner supply roller. The conductive roller is preferably a charging roller.

### Electrophotographic Image Forming Apparatus

The present disclosure provides an electrophotographic image forming apparatus, comprising: an electrophotographic photosensitive member; and a charging roller arranged so as to be capable of charging the electrophotographic photosensitive member, wherein the charging roller is the conductive roller of the present disclosure.

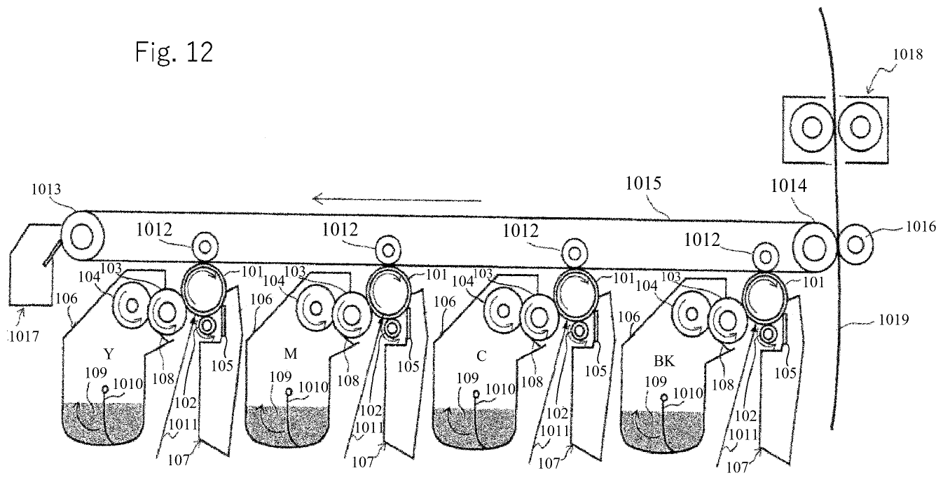

FIG. 12 is a schematic cross-sectional view of the electrophotographic image forming apparatus which uses the conductive roller according to the present disclosure as the charging roller. This electrophotographic image forming apparatus is a color electrophotographic apparatus to which the process cartridge is detachably attached. For each process cartridge, toner of each color (black BK, magenta M, yellow Y and cyan C) is used.

A photosensitive drum 101 rotates in the arrow direction, and is uniformly charged by a charging roller 102 to which voltage is applied from a charging bias power supply, and an electrostatic latent image is formed on the surface of the photosensitive drum 101 by an exposure light 1011. Toner 109, stored in a toner container 106, is supplied to a toner supply roller 104 by a stirring blade 1010, and is conveyed onto a developing roller 103. Then by a developing blade 108, which is disposed contacting the developing roller 103, the toner 109 is uniformly coated on the surface of the developing roller 103, and charges are provided to the toner 109 by triboelectric charging. The above mentioned electrostatic latent image is developed by the toner 109, which is conveyed by the developing roller 103 disposed contacting the photosensitive drum 101, and is visualized as a toner image thereby.

The visualized toner image on the photosensitive drum is transferred to an intermediate transfer belt 1015, which is supported and driven by a tension roller 1013 and an intermediate transfer belt driving roller 1014, by a primary transfer roller 1012 to which voltage is applied by a primary transfer bias power supply. A toner image of each color is sequentially superimposed and a color image is formed on the intermediate transfer belt.

A transfer material 1019 is fed into the apparatus by a paper feeding roller, and is conveyed between the intermediate transfer belt 1015 and a secondary transfer roller 1016. The secondary transfer roller 1016, to which voltage is applied from a secondary transfer bias power supply, transfers the color image on the intermediate transfer belt 1015 to the transfer material 1019. The color image transferred onto the transfer material 1019 is fixed by a fixing unit 1018, and then the transfer material 1019 is discharged out of the apparatus, and print operation ends.

The untransferred toner remaining on the photosensitive drum is scraped off by a cleaning blade 105, is stored in a waste toner container 107, and the cleaned photosensitive drum 101 is subject to a repeat of the above steps. The untransferred toner remaining on the primary transfer belt is scraped off by a cleaning apparatus 1017.

The above is an example of a color electrophotographic apparatus, but in the case of a monochrome electrophotographic apparatus (not illustrated), only a process cartridge containing black toner is used. The monochrome image is directly formed on the transfer member by the process cartridge and the primary transfer roller (there is no secondary transfer roller) without using the intermediate transfer belt. Then the monochrome image is fixed by the fixing unit, and the transfer material is discharged out of the apparatus, whereby print operation ends.

### EXAMPLES

Examples of the present disclosure will now be described, but the technical scope of the present disclosure is not limited thereto.

Examples and comparative examples will be described below. The conductive rollers, as electrophotographic members described in the examples and comparative examples, were prepared using the materials indicated in Table 1.

TABLE 1

| Material | Material | | | |
|---|---|---|---|---|
| type | abbreviation | Material name | Product name | Manufacturer name |
| Rubber | N230SV | Acrylonitrile-butadiene rubber | JSR NBR N230SV | JSR Corp. |
| | | (NBR) | | |
| material | A303 | Styrene-butadiene rubber | Asaprene 303 | Asahi Kasai Corp. |
| | | (SBR) | | |
| | T2003 | Styrene-butadiene rubber | Tufdene 2003 | Asahi Kasai Corp. |
| | | (SBR) | | |
| | E505A | Ethylene-propylene-diene | Esplene505A | Sumitomo Chemical |
| | | rubber (EPDM) | | Co., Ltd. |
| | BR150B | Polybutadiene rubber (BR) | UBEPOL BR150B | Ube Corp. |
| | IR2200L | Isoprene rubber (IR) | Nipol IR2200L | Zeon Corp. |
| | B31 | Chloroprene rubber (CR) | SKYPRENE B31 | Tosoh Corp. |
| | Butyl 065 | Butyl rubber (Butyl) | JSR Butyl 065 | JSR Corp. |
| | CG102 | Epichlorohydrin rubber | Epichlomer CG102 | Osaka Soda Co., Ltd. |
| | CG103 | Epichlorohydrin rubber | Epichlomer CG103 | Osaka Soda Co., Ltd. |
| Conductive | #7360SB | Conductive carbon black | TOKABLACK#7360SB | Tokai Carbon Co., Ltd. |
| agent | EC100J | Titanium oxide | EC100J | Titan Kogyo, Ltd. |
| | Tin oxide | Tin oxide | S-2000 | Mitsubishi Materials |
| | | | | Electronic Chemicals |
| | | | | Co., Ltd. |
| Vulcanization | PMC | Sulfur | SULFAX PMC | Tsurumi Chemical |
| agent | | | | Industry Co., Ltd. |
| Vulcanization | TB z TD | Tetrabenzylthiuram disulfide | Sanceler TBzTD | Sanshin Chemical |
| accelerator | | | | Industry Co., Ltd. |
| Filler | #30 | Calcium carbonate | Nanox #30 | Maruo Calcium Co., Ltd. |

### Example 1

### 1. Preparing Unvulcanized Rubber Composition Used for Forming Conductive Layer

### 1-1. Preparing Carbon Masterbatch (CMB) for Forming Core

Each material indicated by type and blending amount in Table 2 is mixed using a 6 liter pressurized kneader (product name: TD6-15MDX, made by Toshin Co., Ltd.) to obtain the CMB for forming a core. The mixing conditions are: a filling ratio of 70 vol. %, a blade rotation frequency of 30 rpm, and a kneader temperature of 130° C., for 16 minutes.

TABLE 2

| | | Blending amount |
|---|---|---|
| | Material name | (parts by mass) |
| Second | EPDM | 100 |
| rubber | (Product name: Esplene 505A, made | |
| | by Sumitomo Chemical Co., Ltd.) | |
| Electronic | Carbon black | 60 |
| conductive | (Product name: Toka black #7360SB, | |
| agent | made by Tokai Carbon Co., Ltd.) | |
| Vulcanization | Zinc oxide | 5 |
| acceleration | (Product name: Zinc oxide grade 2, | |
| aid | made by Sakai Chemical Industry | |
| | Co. Ltd.) | |
| Processing | Zinc stearate | 2 |
| aid | (Product name: SZ-2000, made by | |
| | Sakai Chemical Ind. Co. Ltd.) | |

### 1-2. Preparing Rubber Composition (MSC) for Forming Matrix and Shell

Each material indicated by type and blending amount in Table 3 was mixed using a 6 liter pressurized kneader (product name: TD6-15MDX, made by Toshin Co., Ltd.) to obtain the rubber composition for forming a matrix and a shell. The mixing conditions are: a filling ratio of 70 vol. %, a blade rotation frequency of 30 rpm, and a kneader temperature of 100° C., for 16 minutes.

TABLE 3

| | | Blending amount |
|---|---|---|
| | Material name | (parts by mass) |
| First rubber | NBR | 80 |
| | (Product name: JSR NBR N230SV, | |
| | made by JSR Co., Ltd.) | |
| Third rubber | T2003 | 20 |
| | (Product name: Tufdene 2003, | |
| | made by Asahi Kasai Corp.) | |
| Filler | Calcium carbonate | 40 |
| | (Product name: Nanox #30, made | |
| | by Maruo Calcium Co., Ltd.) | |
| Vulcanization | Zinc oxide | 5 |
| acceleration aid | (Product name: Zinc Oxide Grade 2, | |
| | made by Sakai Chemical Ind. Co. Ltd.) | |
| Processing aid | Zinc stearate | 2 |
| | (Product name: SZ2000, made by | |
| | Sakai Chemical Industry Co., Ltd.) | |

### 1-3. Preparing Unvulcanized Rubber Composition for Forming Conductive Layer

Each material indicated by type and blending amount in Table 4 was mixed having an open roll, to obtain an unvulcanized rubber composition for forming a conductive layer. The mixing machine used here is an open roll of which roll diameter is 12 inches. The mixing conditions are: a front roll rotation frequency of 10 rpm and a rear roll rotation frequency of 8 rpm. After switching the roll at the left and right a total of 20 times with a roll gap of 2 mm, right milling is performed 10 times with a roll gap of 1.0 mm.

TABLE 4

| | | Blending amount |
|---|---|---|
| | Material name | (parts by mass) |
| Material rubber | Rubber composition for forming core (CMB) | 11 |
| Material rubber | Rubber composition for forming matrix and shell (MSC) | 89 |
| Vulcanizing | Sulfur | 3 |
| agent | (Product name: SULFLAX PMC, sulfur component 97.5% | |
| | made by Tsurumi Chemical Industry Co. Ltd.) | |
| Vulcanization | Tetrabenzyl thiuram disulfide | 1 |
| accelerator 1 | (Product name: Sanceler TBzTD, made by Sanshin | |
| | Chemical Industry Co. Ltd.) | |
| Vulcanization | N-t-butyl-2-benzothiazole sulfenamide | 0.5 |
| accelerator 2 | (Product name: SANTOCRE-TBSI, made by FLEXSYS | |
| | Corp.) | |

### 2. Preparing Electrophotographic Member (Conductive Roller)

### 2-1. Forming Conductive Layer

For the support member, a core metal (252 mm long, 6 mm outer diameter), generated by performing electroless nickel plating on the surface of free cutting steel, was prepared. This core metal was used as a conductive shaft core (support member). Then using a roll coater, an adhesive (product name: Metaloc U-20, made by Toyokagaku Kenkyusho, Co. Ltd.) was coated on the entire surface of the core metal in a 230 mm range, excluding each end 11 mm thereof. In this example, the core metal coated with adhesive was used as the conductive support member.

Then a die (inner diameter: 8.4 mm) was attached to a tip of the cross-head extruder which included a supply mechanism of the conductive support member and a discharge mechanism of the unvulcanized rubber roller. The temperature of the extender and the cross-head was adjusted to 100° C., and the conveying speed of the conductive support member was adjusted to 60 mm/sec. Under these conditions, the unvulcanized rubber composition for forming a conductive layer was supplied using the extruder, and the outer peripheral portion of the conductive support member was coated with the unvulcanized rubber composition for forming a conductive layer inside the cross-head, whereby an unvulcanized rubber roller was obtained.

Then the unvulcanized rubber roller was placed in a hot air vulcanizing furnace (170° C.) and was heated for 60 minutes, whereby the unvulcanized rubber composition was vulcanized, and the conductive layer where a conductive layer was formed on the outer peripheral portion of the conductive support member was obtained. Then 10 mm of each end of the conductive layer was cut off, so that the length of the conductive layer in the longitudinal direction becomes 232 mm.

### 3. Characteristic Evaluation

### 3-1. Measuring Volume Resistivity of Matrix

The volume of the matrix is measured in the contact mode as follows using the scanning probe microscope (SPM) (product name: Q-Scope 250, made by Quesant Instrument Corp.). The measurement environment is a temperature of 23° C. and relative humidity of 50%.

First, about a 2 μm thick slice is cut out from the center position of the conductive layer of the charging roller 1 in the longitudinal direction at a cutting temperature of −100° C. using a microtome (product name: Leica EMFCS, made by Leica Microsystems). When the length of the conductive layer in the longitudinal direction is L, and the thickness of the conductive layer is T, a cross section of the conductive layer in the thickness direction is obtained as indicated in FIG. 5B at three location (center of L, L/4 from the each end toward the center).

For each of the obtained cross sections, measurement is performed in a 15 μm² observation region disposed at locations, i.e., 03T, 0.6T and 0.8T, in the thickness region from the outer surface of the conductive layer toward the support member at the depth 0.1T to 0.9T. Then the arithmetic average of the measured values at a total of 9 locations (3 locations on each cross section) is calculated.

Then this slice is placed on a metal plate such that one surface of the slice, corresponding to the cross section of the conductive layer, contacts with the surface of the metal plate. Then a cantilever of the SPM is contacted with a location corresponding to the matrix on the surface of the slice, opposite the surface contacting with the metal plate. Then a 50V voltage is applied to the cantilever, and the current value is measured. Further, the surface profile of this slice is observed using the SPM, and the thickness of the measurement location is calculated based on the obtained height profile. Also based on the observation result of the surface profile, the surface area of the recessed portions of the portion contacting the cantilever is calculated. Then the volume resistivity is calculated from this thickness and the surface area of the recessed portions, and the result is regarded as the volume resistivity of the matrix.

To distinguish the matrix, core and shell, the slice is cut at 60 nm intervals using the FIB-SEM, and obtained cross sections are observed using the image analyzer (product name: LUZEX-AP, made by Nireco Corp.). To make observation with the SEM easier, pre-treatment, to obtain a clear contrast of the matrix, core and shell, is performed. Specifically, osmium tetroxide is used for dyeing. Since dyeing progresses more as the amounts of double bonds and benzene rings of the rubber are higher, the type of the rubber is determined and the matrix, the core and the shell are distinguished thereby. Based on this, it is confirmed where the matrix, the core and the shell are distinguished in the locations measured by the SPM.

### 3-2. Measuring Volume Resistivity of Shell

A slice was cut out using the same method as the method for measuring the volume resistivity of the matrix. Then the slice was section at 60 nm intervals using FIB-SEM, and a centroid was calculated for the acquired cross-sections using an image analyzing apparatus (product name: LUZEX-AP, made by Nireco Corp.), and the shell of the cross-section at the position with which the cantilever was contacted was measured using the same method described for measuring the volume resistivity of the matrix. Then the arithmetic average value of the values measured at the measurement positions was calculated.

The same step was repeated until the sectioning of the entire domain ends. For the three-dimensional image obtained by FIB-SEM, the centroid of volume was calculated using the image analyzing apparatus (product name: LUZEX-AP, made by Nireco Corp.), and was analyzed if the centroid of volume exists inside the domain. If the domain was domain A, the volume resistivity of the shell on the cross-section closest to the centroid of volume of the domain was regarded as the volume resistivity of the shell.

### 3-3. Measuring Thickness of Shell

The following measurement was performed to evaluate the thickness of the shell. The slice was cut out in the same way as the measurement for the volume resistivity of the matrix described above. Then the slice was sectioned at 60 nm intervals using FIB-SEM, and a centroid was calculated for the obtained cross-sections using an image analyzing apparatus (product name: LUZEX-AP, made by Nireco Corp.). Then platinum was deposited on the obtained cross-section, and an image of the platinum-deposited surface was captured using SEM (product name: S-4800, made by Hitachi High Tech Corp.), at 10,000 times magnification, so as to obtain an SEM image.

Then 8-bit grayscale processing was performed on this SEM image using the image analyzing apparatus (product name: LUZEX-AP, made by Nireco Corp.), whereby a 256 gradation monochrome image was obtained. Then the black and white of the ternarized image was inverted so that the dyed shell in the monochrome image becomes white, then the image was binarized by setting a binarization threshold for the brightness distribution of the image, based on the algorithm of Otsu's discriminant analysis method. From the obtained binary image, the thickness of the shell was calculated. This step was repeated until the sectioning of the entire domain ends. For the three-dimensional image obtained by FIB-SEM, the centroid of volume was calculated using the image analyzing apparatus (product name: LUZEX-AP, made by Nireco Corp.), and was analyzed if the centroid of volume exists inside the domain. If the domain was the domain A, the thickness of the shell on the cross-section closest to the centroid of volume of the domain was regarded as the thickness of the shell of the domain A.

When the thickness of the conductive layer is T, a 15 μm square observation region is disposed at 3 locations (0.3T, 0.6T, 0.8T) in the thickness region from the outer surface at a depth of 0.1T to 0.9T for the 3 slices respectively. In each observation region, the thickness of the shell is calculated, and the arithmetic average of the measured values of the thickness of each shell for a total of the 3 observation regions is calculated.

### 3-4. Measuring Volume Resistivity of Core

The volume resistivity of the core was measured in a same manner as the above mentioned measurement method for the volume resistivity of the matrix, except that the contact position of the cantilever was a location corresponding to the core, and the voltage applied to the cantilever was 1V. Then the average value of the values measured at the measurement positions was calculated.

### 3-5. Measuring Charge Attenuation Rate on Charging Roller Surface

A surface potential of the charging roller, after corona discharge, was measured using a charge amount measuring apparatus (product name: DRA-2000L, made by QEA Inc.). Specifically, a corona discharger of the charge amount measuring apparatus was disposed such that a gap between a grid portion and the charging roller surface became 1 mm. Then a discharge was generated by applying an 8 kV voltage to the corona discharger, so as to charge the charging roller surface, and the surface potential immediately after this charging (immediately after the end of discharge) and the surface potential of the charging roller 10 seconds later were measured.

The charge attenuation rate Q (%) was then calculated using the following Expression (7), where E0 was the surface potential immediately after charging, and E10 was the surface potential 10 seconds later after the end of discharge (or after charging).

$$Q = \{ ( E 0 - E 10 ) / E 0 \} \times 100 \qquad ( 7 )$$

### 3-6. Measuring Impedance

As pre-treatment, platinum was deposited on the outer surface of the charging roller (electrophotographic member) while rotating the charging roller, whereby a measurement electrode (platinum electrode) was created. Here using masking tape, an electrode, having a 1.5 cm width and that was uniform in the circumferential direction, was created. By creating this electrode, the negative influence of surface roughness of the electrophotographic member, on the contact area of the measurement electrode and the electrophotographic member, can be minimized.

Then an aluminum sheet was wound around this electrode with no gap, whereby the measurement sample was created. Then an impedance measuring apparatus (product name: Solartron 1260 and Solartron 1296, made by Solartron Co.) was connected to the measurement electrode via the aluminum sheet, and to the outer surface of the support member.

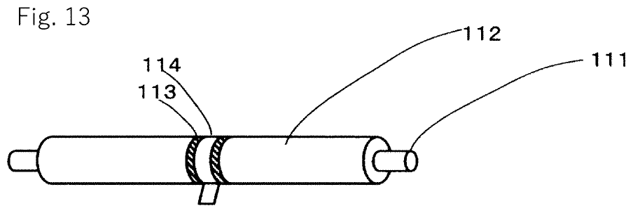

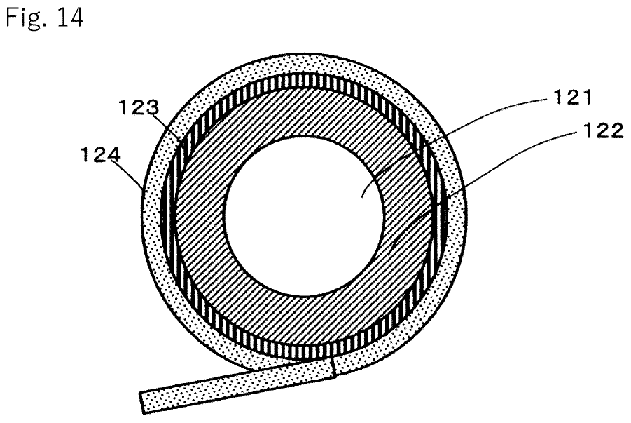

FIGS. 13 and 14 are schematic diagrams depicting a state where the measurement electrode was formed on the charging roller. In FIG. 13, 111 is the conductive support member, 112 is the conductive layer, 113 is the platinum-deposited layer, and 114 is the aluminum sheet. In FIG. 14, 121 is the conductive support member, 122 is the conductive layer having a matrix-domain structure, 123 is the aluminum-deposited layer, and 124 is the aluminum sheet.

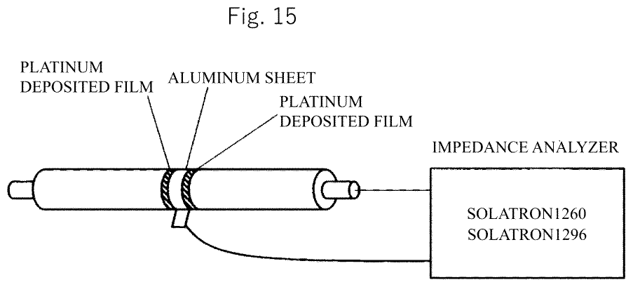

FIG. 14 is a cross-sectional view depicting a state where the measurement electrode is formed on the charging roller. As illustrated in FIG. 14, it is important to dispose the conductive layer having the matrix-domain structure between the conductive support member and the measurement electrode. Then as illustrated in FIG. 15, the aluminum sheet and the outer surface of the support member were connected to the measurement electrodes on the side of the impedance measuring apparatus (product name: Solartron 1260 and Solartron 1296, made by Solartron Co.). Impedance was measured by using the conductive support member and the aluminum sheet as two electrodes for measurement.

Impedance was measured in the environment of a temperature of 23° C. and a relative humidity of 50%, at amplitude 1V and frequency 1.0×10⁻² to 1.0×10⁷ Hz. Here the measurement locations were changed every time the frequency changes 1 digit, and measurement was performed for five locations each time. The measurement locations were the center portion of each region determined by equally dividing the longitudinal direction (axial direction) of the electrophotographic member into five. The absolute value of the impedance was obtained by determining the arithmetic average value of these measured values.

Then using the measurement result, the absolute value of the impedance was plotted on the ordinate and the frequency was plotted on the abscissa in the log-log graph. Here the slope of the impedance in the frequency 1.0×10⁻² to 1.0×10¹ Hz (low frequency impedance) and the slope of the impedance in the frequency 1.0×10⁵ to 1.0×10⁶ Hz (high frequency impedance) were calculated.

### 3-7. Observing of Roller Surface Structure

R2/R1 and the ratio of the number of line segments LS are calculated using the method described above in <Observing of surface structure for Requirements (4-1) and (4-2)>.

### 3-8. Observing of Portion C and Portion E of Roller Cross Section

Based on the method described in <Measurement method for portion E>, the ratio of the portion E existing directly under the portion C is calculated using osmium tetroxide for dyeing.

### 4. Image Evaluation

### Image Evaluation 1: Evaluating Charging Capability

The following evaluation was performed to confirm the function to suppress leaking of discharge of the charging roller 1.

First an electrophotographic type laser printer (product name: Laserjet M608dn, made by HP Co.) was prepared as an electrophotographic apparatus. Then the charging roller 1, the electrophotographic apparatus and the process cartridge were left for 48 hours in a 23° C./50% RH environment, so as to adjust to the measurement environment.

To perform the evaluation in a high-speed process, this laser printer was modified such that the number of sheets to be outputted per unit minute becomes 75 sheets/minute (A4 sized paper), which was more than the original output the number of sheets. Here the output speed of the recording media was set to 370 mm/sec., and the image resolution was set to 1200 dpi. The pre-exposing apparatus in the laser print was removed. Further, the process cartridge was modified such that the drum surface potential, after the charging process, could be measured using a surface potential probe (main body: Model 347, probe: Model 3800S-2, made by Trek Co. Ltd.).

The charging roller 1, which was left in the above mentioned environment, was set as the charging roller of the process cartridge, and was attached to the laser printer. In the same environment as above, a −1000V voltage was applied to the charging roller 1 using an external power supply (Trek 615, made by Trek Japan Co.), and a solid white image and a solid black image were outputted thereby, then the surface potential of the photosensitive drum at this time was measured. Then the difference (black and white potential difference) between the surface potential of the photosensitive drum after the charging process when the solid black image was outputted and the surface potential of the photosensitive drum after the charging process when the solid white image was outputted was calculated. Table 7 and Table 10 are the results thereof. Low black and white potential difference means that the charging capability of the charging roller is high.

### 4-2. Evaluating Ghost Image

The effect of generating uniform discharge in the high-speed process of the charging roller 1, even if the surface potential of the photosensitive drum before charging is uneven, was confirmed using the following method.

To form an evaluation image, the laser printer, used for “evaluating the charging capability” mentioned above, was used. Just like the case of “evaluating the charging capability”, the charging roller 1, the laser printer and the process cartridge were left for 48 hours in a 23° C./50% RH environment, so as to adjust to the measurement environment, and the evaluation image was formed in the same environment. The evaluation image had the characters “E” on the upper part of the image, and had a half tone image below the center portion of the image. Table 7 and table 10 are the results thereof.

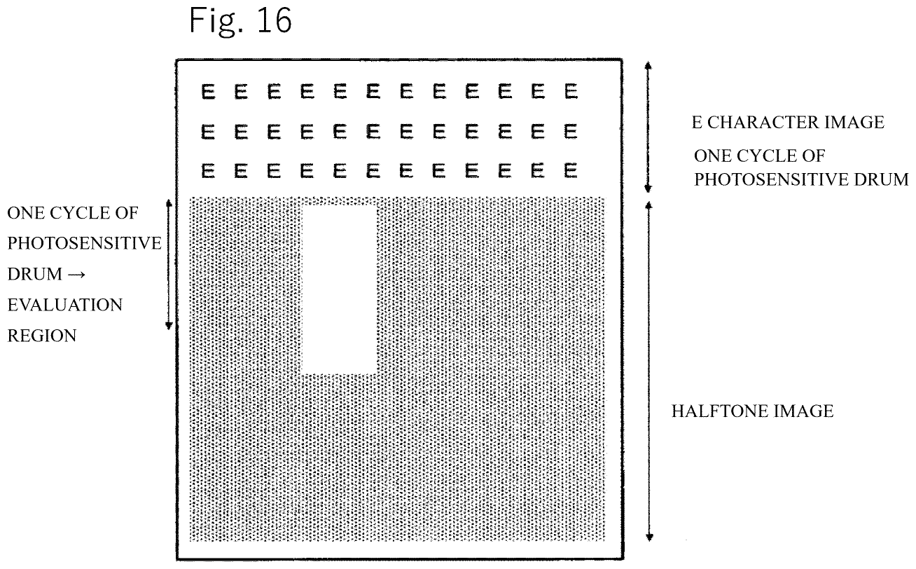

Specifically, in the upper 10 cm region of the image, the alphabetic characters “E” (size: 4 pt.) were printed so as to cover 4% of the surface area of the A4 sized paper. Thereby after the transfer process, the surface potential (before the charging process) of the photosensitive drum can form an initial unevenness along the surface potential corresponding to the characters “E” in a region covered by one cycle of the photosensitive drum. FIG. 16 is a diagram for describing this evaluation image.

Further, a halftone image (image generated by drawing horizontal lines of a 1 dot width and 2 dot space in the direction vertical to the rotating direction of the photosensitive drum) was outputted below the upper 10 cm. This halftone image was visually observed and evaluated based on the following standards. Table 7 and Table 10 are the results thereof.

### Evaluating Characters “E” on Halftone Image (Ghost Image)

Rank A: No image unevenness caused by the characters “E” is observed on the halftone image, even if a microscope is used.
Rank B: No image unevenness caused by the characters “E” is visually observed on the halftone image, but is observed on part of the halftone image if a microscope is used.
Rank C: An image of the characters “E” is visually observed on part of the halftone image.
Rank D: An image of characters “E” is visually observed on the entire surface of the halftone image.

### Image Evaluation 3: Evaluating Transverse Discharge on Halftone Image

Traverse discharge can also be confirmed depending on whether color loss, of which length in the conductive roller shaft direction is 500 μm or more, is generated on the halftone image used for evaluating the ghost image. The evaluation is performed based on the following standards.
OK: a number of color losses, of which length in the conductive roller shaft direction is 500 μm or more, is less than 10
NG: a number of color omissions, of which length in the conductive roller shaft direction is 500 μm or more, is 10 or more

### Image Evaluation 2: Evaluating White Spot Image

The following evaluation was performed to confirm the contamination resistant performance when the charging roller 1 is used over a long period of time. First an electrophotographic type laser printer (product name: Laserjet Pro M203dw, made by HP Co.), was prepared as an electrophotographic apparatus. Then to perform the evaluation in a high-speed process, this laser printer was modified such that the number of sheets to be outputted per minute became 75 sheets/minute (A4 sized paper), which was more than the original output number of sheets. Here the output speed of the recording media was set to 370 mm/sec. Then the charging roller 1, the electrophotographic image forming apparatus and the process cartridge were left for 48 hours in a 15° C./30% RH environment, so as to adjust to the measurement environment.

The charging roller 1, which was left in the above mentioned environment, was set as the charging roller of the process cartridge, and was attached to the laser printer. Then in the same environment, a total of 50,000 sheets of images were consecutively outputted. For the outputted image, alphabetic characters “E” (size: 4 pt.) were printed at a print ratio of 1.0% on A4 sized paper. Then a halftone image (image generated by drawing horizontal lines of a 1 dot width and 2 dot space in the direction vertical to the rotating direction of the photosensitive drum) was outputted. This halftone image was visually observed, and white spot images were evaluated based on the following standards.

### Evaluating White Spot Images on Halftone Image

Rank A: No white spot image is observed on the halftone image even if a microscope is used.
Rank B: No white spot image is visually observed on the halftone image, but is observed if a microscope is used.
Rank C: A white spot image is visually observed on a part of the halftone image.
Rank D: A white spot image is visually observed on the entire surface of the halftone image.

### Examples 2 to 15

Charging rollers 2 to 15 are prepared respectively by the same method as the charging roller 1 in Example 1, except that the starting materials are changed, as indicated in Table 5 and Table 6. Table 5 and Table 6 indicate the parts by mass and the physical properties of each starting material used for preparing each charging roller. Table 7 indicates the result of characteristics evaluations and the image evaluation of the completed charging rollers 2 to 15.

TABLE 5

| Unvulcanized | | | | | | | | | | | | | | |
|---|---|---|---|---|---|---|---|---|---|---|---|---|---|---|
| rubber | | | | | | | | | | | | | | |
| composition | Rubber composition for forming matrix and shell (MSC) | | | | | | | | | | | | | |
| for forming | First rubber | | | | | Third rubber | | | | | | | Zinc | Zinc |
| conductive | | | | SP | parts | | | | SP | | Filler | | oxide | stearate |
| layer | type | name | M | value | | type | name | M | value | parts | name | parts | parts | parts |
| E-1 | NBR | N230SV | 32 | 20.0 | 80 | SBR | T2003 | 33 | 17.0 | 20 | #30 | 40 | 5 | 2 |
| E-2 | NBR | N230SV | 32 | 20.0 | 80 | SBR | T2003 | 33 | 17.0 | 20 | #30 | 40 | 5 | 2 |
| E-3 | NBR | N230SV | 32 | 20.0 | 80 | SBR | T2003 | 33 | 17.0 | 20 | #30 | 40 | 5 | 2 |
| E-4 | NBR | N230SV | 32 | 20.0 | 80 | SBR | T2003 | 33 | 17.0 | 20 | #30 | 40 | 5 | 2 |
| E-5 | NBR | N230SV | 32 | 20.0 | 80 | SBR | T2003 | 33 | 17.0 | 20 | #30 | 40 | 5 | 2 |
| E-6 | NBR | N230SV | 32 | 20.0 | 80 | SBR | T2003 | 33 | 17.0 | 20 | #30 | 40 | 5 | 2 |
| E-7 | NBR | N230SV | 32 | 20.0 | 80 | SBR | T2003 | 33 | 17.0 | 20 | #30 | 40 | 5 | 2 |
| E-8 | NBR | N230SV | 32 | 20.0 | 80 | IR | IR2200L | 70 | 16.5 | 20 | #30 | 40 | 5 | 2 |
| E-9 | NBR | N230SV | 32 | 20.0 | 80 | BR | BR150B | 40 | 16.8 | 20 | #30 | 40 | 5 | 2 |
| E-10 | NBR | N230SV | 32 | 20.0 | 80 | SBR | T2003 | 33 | 17.0 | 20 | #30 | 40 | 5 | 2 |
| E-11 | NBR | N230SV | 32 | 20.0 | 80 | SBR | T2003 | 33 | 17.0 | 20 | #30 | 40 | 5 | 2 |
| E-12 | NBR | N230SV | 32 | 20.0 | 80 | SBR | T2003 | 33 | 17.0 | 20 | #30 | 40 | 5 | 2 |
| E-13 | CR | B31 | 40 | 17.4 | 80 | SBR | T2003 | 33 | 17.0 | 20 | #30 | 40 | 5 | 2 |
| E-14 | NBR | N230SV | 32 | 20.0 | 80 | SBR | T2003 | 33 | 17.0 | 20 | #30 | 40 | 5 | 2 |
| E-15 | NBR | N230SV | 32 | 20.0 | 60 | SBR | T2003 | 33 | 17.0 | 40 | #30 | 40 | 5 | 2 |

TABLE 6

| Unvulcanized | | | | | | | | | | | |
|---|---|---|---|---|---|---|---|---|---|---|---|
| rubber | | | | | | | | | | | |
| composition | Rubber composition for forming core (CMB)) | | | | | | | | | | |
| for forming | Second rubber | | | | | Conductive | | Zinc | Zinc | ratio | |
| conductive | | | | SP | | particle | | oxide | stearate | MSC | CMB |
| layer | type | name | M | value | parts | name | parts | parts | parts | parts | parts |
| E-1 | EPDM | E505A | 47 | 16.0 | 100 | #7360SB | 60 | 5 | 2 | 89 | 11 |
| E-2 | EPDM | E505A | 47 | 16.0 | 100 | #7360SB | 60 | 5 | 2 | 72 | 28 |
| E-3 | EPDM | E505A | 47 | 16.0 | 100 | #7360SB | 60 | 5 | 2 | 70 | 30 |
| E-4 | EPDM | E505A | 47 | 16.0 | 100 | #7360SB | 60 | 5 | 2 | 69 | 31 |
| E-5 | EPDM | E505A | 47 | 16.0 | 100 | #7360SB | 30 | 5 | 2 | 74 | 26 |
| E-6 | EPDM | E505A | 47 | 16.0 | 100 | Tin oxide | 60 | 5 | 2 | 74 | 26 |
| E-7 | EPDM | E505A | 47 | 16.0 | 100 | #7360SB | 60 | 5 | 2 | 64 | 36 |
| E-8 | EPDM | E505A | 47 | 16.0 | 100 | #7360SB | 60 | 5 | 2 | 74 | 26 |
| E-9 | EPDM | E505A | 47 | 16.0 | 100 | #7360SB | 60 | 5 | 2 | 74 | 26 |
| E-10 | IR | IR2200L | 70 | 16.5 | 100 | #7360SB | 60 | 5 | 2 | 74 | 26 |
| E-11 | BR | BR150B | 40 | 16.8 | 100 | #7360SB | 60 | 5 | 2 | 74 | 26 |
| E-12 | Butyl | JSR Butyl | 32 | 15.8 | 100 | #7360SB | 60 | 5 | 2 | 74 | 26 |
| | | 065 | | | | | | | | | |
| E-13 | EPDM | E505A | 47 | 16.0 | 100 | #7360SB | 60 | 5 | 2 | 74 | 26 |
| E-14 | EPDM | E505A | 47 | 16.0 | 100 | #7360SB | 60 | 5 | 2 | 74 | 26 |
| E-15 | EPDM | E505A | 47 | 16.0 | 100 | #7360SB | 60 | 5 | 2 | 74 | 26 |

In Tables 5, 6, 8 and 9, the unit of the SP value is (J/cm³)^{0.5}. “M” indicates Mooney viscosity, and the Mooney viscosity was determined by measuring the Mooney viscosity ML₍₁₊₄₎ at the rubber temperature during kneading based on JISK6300-1:2013, and “parts” indicates parts by mass.

TABLE 7

| | | | Physical property near | | | | | | | |
|---|---|---|---|---|---|---|---|---|---|---|
| | | | roller surface | | | Cross- | | | | |
| | | Unvulcanized | | Ratio of | | sectional | | | | |
| | | rubber | | lines | | structure of | Physical property of roller | | | |
| | | composition | | passing | | roller | Low | High | | Matrix |
| | | for forming | | through | Ratio of | Ratio of | frequency | frequency | Charge | Volume |
| Example | Charging | conductive | | portion | number | portion | impedance | impedance | attenuation | resistivity/ |
| No. | roller No. | layer | R2/R1 | M % | of LS % | E % | Ω | slope | rate % | Ω · cm |
| 1 | 1 | E-1 | 0.50 | 80 | 2 | 80 | 8.11E+04 | −0.36 | 72 | 2.25E+09 |
| 2 | 2 | E-2 | 0.60 | 50 | 3 | 80 | 8.11E+04 | −0.36 | 72 | 2.25E+09 |
| 3 | 3 | E-3 | 0.80 | 20 | 4 | 50 | 8.11E+04 | −0.36 | 72 | 2.25E+09 |
| 4 | 4 | E-4 | 0.83 | 10 | 5 | 30 | 8.11E+04 | −0.36 | 72 | 2.25E+09 |
| 5 | 5 | E-5 | 0.55 | 48 | 3 | 30 | 2.52E+05 | −0.52 | 66 | 2.31E+09 |
| 6 | 6 | E-6 | 0.55 | 48 | 3 | 30 | 9.14E+04 | −0.51 | 69 | 1.59E+00 |
| 7 | 7 | E-7 | 0.55 | 48 | 3 | 30 | 8.45E+04 | −0.54 | 71 | 1.97E+09 |
| 8 | 8 | E-8 | 0.89 | 10 | 5 | 30 | 6.10E+03 | −0.46 | 71 | 2.31E+09 |
| 9 | 9 | E-9 | 0.55 | 48 | 3 | 30 | 2.28E+04 | −0.52 | 72 | 2.10E+09 |
| 10 | 10 | E-10 | 0.55 | 48 | 3 | 30 | 8.43E+04 | −0.54 | 70 | 2.04E+09 |
| 11 | 11 | E-11 | 0.55 | 48 | 3 | 30 | 8.72E+04 | −0.53 | 73 | 1.86E+09 |
| 12 | 12 | E-12 | 0.55 | 48 | 3 | 30 | 8.26E+04 | −0.53 | 71 | 2.00E+09 |
| 13 | 13 | E-13 | 0.55 | 48 | 3 | 30 | 8.31E+04 | −0.52 | 56 | 5.33E+10 |
| 14 | 14 | E-14 | 0.55 | 48 | 3 | 30 | 8.40E+04 | −0.46 | 70 | 2.31E+09 |
| 15 | 15 | E-15 | 0.55 | 48 | 3 | 30 | 8.10E+04 | −0.48 | 68 | 2.05E+09 |

| | Domain | | | | | | | | |
|---|---|---|---|---|---|---|---|---|---|
| | Core | | | | | Image evaluation 1 | | | |
| | | Cross- | | | | (ghost) | | Image | |
| | | sectional | | | | Black/ | | evaluation 2 | Image |
| | | ratio of | Shell | | | white | | (white spots) | evaluation 3 |
| | Volume | electronic | Volume | | Number | potential | | White spot | (color loss) |
| Example | resistivity/ | conductive | resistivity/ | Thickness/ | % of | difference/ | Ghost | rank @ | Transverse |
| No. | Ω · cm | agent % | Ω · cm | μm | domain A | V | image | 50K | image |
| 1 | 5.89E+01 | 26.1 | 8.74E+13 | 0.52 | 81 | 4 | A | A | OK |
| 2 | 5.89E+01 | 26.1 | 8.74E+13 | 0.52 | 81 | 4 | A | A | OK |
| 3 | 5.89E+01 | 26.1 | 8.74E+13 | 0.52 | 81 | 4 | A | A | OK |
| 4 | 5.89E+01 | 26.1 | 8.74E+13 | 0.52 | 81 | 4 | A | A | OK |
| 5 | 4.87E+01 | 19.0 | 8.54E+13 | 0.29 | 69 | 32 | B | A | OK |
| 6 | 5.66E+01 | 26.0 | 8.05E+13 | 0.3 | 71 | 19 | A | A | OK |
| 7 | 4.76E+01 | 26.0 | 7.67E+13 | 0.25 | 57 | 25 | B | A | OK |
| 8 | 5.29E+01 | 26.1 | 8.40E+15 | 0.3 | 73 | 8 | A | A | OK |
| 9 | 6.39E+01 | 26.0 | 3.13E+15 | 0.26 | 70 | 11 | A | A | OK |
| 10 | 5.47E+01 | 26.2 | 8.10E+13 | 0.31 | 30 | 19 | A | A | OK |
| 11 | 4.82E+01 | 26.2 | 7.81E+13 | 0.29 | 25 | 18 | A | A | OK |
| 12 | 4.44E+01 | 25.9 | 8.34E+13 | 0.32 | 23 | 15 | A | A | OK |
| 13 | 4.57E+01 | 26.3 | 7.90E+13 | 0.16 | 40 | 16 | A | B | OK |
| 14 | 6.13E+01 | 26.0 | 8.30E+13 | 0.25 | 65 | 19 | A | A | OK |
| 15 | 4.78E+01 | 26.1 | 8.99E+13 | 0.68 | 75 | 24 | A | A | OK |

In table 7, the ratio of the lines passing through the portion M indicates the “ratio of a number of lines crossing the portion M, with respect to 99 lines (%)”.

The ratio of the number of LS indicates that “ratio of a number line segments LS of which length is 20 μm or more, with respect to the total number of line segments LS (%)”.

The ratio of portion E indicates the “ratio of the portion E existing directly under the portion C, with respect to the number of portions C (%)”.

The low frequency impedance indicates the impedance when the frequency is 1.0×10⁻² to 1.0×10¹ Hz. The high frequency impedance slope indicates the slope when the frequency is 1.0×10⁵ to 1.0×10⁶ Hz.

In the above tables, 8.11E+04, for example, indicates 8.11×10⁴.

### Comparative Examples 1 to 6

Charging rollers are prepared respectively by the same method as Example 1, except that the materials to be used are changed as indicated in Table 8 and Table 9. Table 10 indicates the result of characteristics evaluation and the image evaluation of the completed charging rollers 16 to 21.

### Comparative Example 7

The surface of the conductive layer of the roller of which processing progressed after vulcanization of Example 1 is ground using a rotary grindstone. Then the roller is prepared under the same conditions as the above examples. Table 10 indicates the results of characteristics evaluation and image evaluation of the completed roller 22.

### Comparative Example 8

The material for the core indicated in Table 2 is formed in a sheet of which thickness is 20 μm, and is uniformly wrapped in a single layer around the conductive layer of the unvulcanized roller of Example 1. The unvulcanized rubber composition is then placed in a hot air vulcanization furnace at 170° C. and heated for 60 minutes to vulcanize the unvulcanized rubber composition, thereby obtaining a conductive roller having a conductive layer formed on the outer periphery of the conductive support member. Then 10 mm is cut from each end of the conductive layer, so that the length of the conductive layer in the longitudinal direction becomes 232 mm. Table 10 indicates the result of characteristics evaluation and image evaluation of the completed charging roller 23.
In Comparative Example 1, because of the volume resistivity of the rubber of the matrix, movement of the charges can be limited within a domain, and the drum ghost images can be suppressed. On the other hand, the charge attenuation rate is low and contaminating substances are charged up, which is the probable reason why an abnormal discharge is generated and white spot images are generated
In Comparative Example 2, because of the volume resistivity of the rubber of the matrix, the charge attenuation rate is high and white spots can be suppressed. However the third rubber does not exist, which is the probable reason why the charges cannot be stored in the domain sufficient, and the drum ghost images are generated.
The Comparative Example 3 is a configuration without the domain-matrix structure, and movement of the charges cannot be suppressed by the domain, which is the probable reason why the drum ghost images are generated.
In Comparative Examples 4 and 5, the second rubber and the third rubber are the same, and the domain A having a core-shell structure is not formed, which is the probable reason why the drum ghost images are generated.
In Comparative Example 6, the core has an ion conductive configuration. In the case of an ion conductive core, there is no charge storing capability at the interface between the electronic conductive agent and the second rubber in the domain, and the effect of suppressing the leaking of charges in the domain diminishes, which is the probable reason why the drum ghost images are generated. Further, in the configuration of an ion conduction, the transporting speed of charges is slower than an electronic condition, and the charge attenuation rate drops, which is the probable reason why the white spots are generated.
In Comparative Example 7, the outer surface of the conductive layer is ground, and the surface has the matrix-domain structure, which is the same as the inside of the conductive layer. Therefore R1 in the ratio of R2 and R1 on the surface is large, and the uniform charging performance is not good, which is the probable reason why the color loss images are generated.
In Comparative Example 8, the front surface is constituted only of a core material containing the electronic conductive material, and no line segments crossing the portion M exist. Therefore the transverse discharge on the outermost surface of the roller cannot be cut off, which is the probable reason why the color loss image is generated.

TABLE 8

| Unvulcancized | | | | | | | | | | | | | | |
|---|---|---|---|---|---|---|---|---|---|---|---|---|---|---|
| rubber | | | | | | | | | | | | | | |
| composition | Rubber composition for forming matrix and shell (MSC) | | | | | | | | | | | | | |
| for forming | First rubber | | | | | Third rubber | | | | | | | Zinc | Zinc |
| conductive | | | | SP | parts | | | | SP | | Filler | | oxide | stearate |
| layer | type | name | M | value | | type | name | M | value | parts | name | parts | parts | parts |
| E-16 | SBR | T2003 | 33 | 17.0 | 100 | — | — | — | — | — | #30 | 40 | 5 | 2 |
| E-17 | NBR | N230SV | 32 | 20.0 | 100 | — | — | — | — | — | #30 | 40 | 5 | 2 |
| E-18 | — | — | — | — | — | — | — | — | — | — | — | — | — | — |
| E-19 | NBR | N230SV | 32 | 20.0 | 80 | EPDM | E505A | 47 | 16.0 | 20 | #30 | 40 | 5 | 2 |
| E-20 | NBR | N230SV | 32 | 20.0 | 80 | EPDM | E505A | 47 | 16.0 | 20 | #30 | 40 | 5 | 2 |
| E-21 | NBR | N202S | 57 | 20.4 | 80 | NBR | N230SV | 32 | 20.0 | 80 | #30 | 40 | 5 | 2 |
| E-22 | NBR | N230SV | 32 | 20.0 | 80 | SBR | T2003 | 33 | 17.0 | 20 | #30 | 40 | 5 | 2 |
| E-23 | NBR | N230SV | 32 | 20.0 | 80 | SBR | T2003 | 33 | 17.0 | 20 | #30 | 40 | 5 | 2 |

TABLE 9

| Unvulcanized | | | | | | | | | | | |
|---|---|---|---|---|---|---|---|---|---|---|---|
| rubber | | | | | | | | | | | |
| com position | Rubber composition for forming core (CMB) | | | | | | | | | | |
| for forming | Second rubber | | | | | Conductive | | Zinc | Zinc | ratio | |
| conductive | | | | SP | | particle | | oxide | stearate | MSC | CMB |
| layer | type | name | M | value | parts | name | parts | parts | parts | parts | parts |
| E-16 | NBR | N230SV | 32 | 20.0 | 100 | #7360SB | 60 | 5 | 2 | 74 | 26 |
| E-17 | SBR | T2003 | 33 | 17.0 | 100 | #7360SB | 60 | 5 | 2 | 74 | 26 |
| E-18 | EPDM | E505A | 47 | 16.0 | 100 | #7360SB | 60 | 5 | 2 | 0 | 100 |
| E-19 | EPDM | E505A | 47 | 16.0 | 100 | #7360SB | 60 | 5 | 2 | 95 | 5 |
| E-20 | EPDM | E505A | 47 | 16.0 | 100 | EC100J | 5 | 5 | 2 | 74 | 26 |
| E-21 | ECO | CG102 | 64 | 18.5 | 100 | — | — | 5 | 2 | 74 | 26 |
| E-22 | EPDM | E505A | 47 | 16.0 | 100 | #7360SB | 60 | 5 | 2 | 82 | 18 |
| E-23 | EPDM | E505A | 47 | 16.0 | 100 | #7360SB | 60 | 5 | 2 | 82 | 18 |

TABLE 10

| | | | Physical property near | | | | | | | |
|---|---|---|---|---|---|---|---|---|---|---|
| | | | roller surface | | | Cross- | | | | |
| | | Unvulcanized | | Ratio of | | sectional | | | | |
| | | rubber | | lines | | structure | Physical property of roller | | | |
| | | composition | | passing | | of roller | Low | High | Charge | Matrix |
| | | for forming | | through | Ratio of | Ratio of | frequency | frequency | attenuation | Volume |
| C.E. | Charging | conductive | | portion | number | portion E | impedance | impedance | rate | resistivity/ |
| No. | roller No. | layer | R2/R1 | M % | of LS % | % | Ω | slope | % | Ω · cm |
| C.E. 1 | 16 | E-16 | 0.55 | 30 | 5 | 30 | 8.78E+04 | −0.63 | 36 | 5.92E+12 |
| C.E. 2 | 17 | E-17 | 0.55 | 30 | 5 | 30 | 1.57E+07 | −1.00 | 71 | 2.58E+09 |
| C.E. 3 | 18 | E-18 | — | — | — | — | 2.55E+08 | −1.00 | 85 | — |
| C.E. 4 | 19 | E-19 | — | — | — | — | 5.50E+10 | −0.85 | 75 | 3.55E+09 |
| C.E. 5 | 20 | E-20 | 0.50 | 30 | 2 | 80 | 2.20E+05 | −0.86 | 65 | 5.50E+09 |
| C.E. 6 | 21 | E-21 | 0.50 | 30 | 2 | 80 | 5.50E+09 | −0.90 | 33 | 2.20E+09 |
| C.E. 7 | 22 | E-22 | 0.25 | 80 | 20 | — | 8.11E+04 | −0.36 | 72 | 2.25E+09 |
| C.E. 8 | 23 | E-23 | 0 | 0 | 0 | — | 8.11E+04 | −0.36 | 72 | 2.25E+09 |

| | Domain | | | | | | | | |
|---|---|---|---|---|---|---|---|---|---|
| | Core | | | | | Image evaluation 1 | | | |
| | | Cross- | | | | (ghost) | | Image | |
| | | sectional | | | | Black/ | | evaluation 2 | Image |
| | | ratio of | Shell | | Number | white | | (white spots) | evaluation 3 |
| | Volume | electronic | Volume | | % of | potential | | White | (color loss) |
| C.E. | resistivity/ | conductive | resistivity/ | Thickness/ | domain | difference/ | Ghost | spot rank | Transverse |
| No. | Ω · cm | agent % | Ω · cm | μm | A | V | image | @ 50K | image |
| C.E. 1 | 6.99E+01 | 26.6 | — | — | — | 36 | B | D | OK |
| C.E. 2 | 5.21E+01 | 26.3 | — | — | — | 62 | D | A | OK |
| C.E. 3 | — | — | — | — | — | 65 | D | B | OK |
| C.E. 4 | 2.22E+01 | 26.2 | 5.50E+16 | 0.32 | — | 62 | D | B | OK |
| C.E. 5 | 2.30E+01 | 12.1 | 3.50E+16 | 0.55 | — | 60 | D | B | OK |
| C.E. 6 | 2.50E+06 | — | 3.20E+16 | 0.34 | 25 | 64 | D | D | OK |
| C.E. 7 | 5.89E+01 | 26.1 | 8.74E+13 | 0.52 | 81 | 4 | A | A | NG |
| C.E. 8 | 5.89E+01 | 26.1 | 8.74E+13 | 0.52 | 81 | 4 | A | A | NG |

In Table 10, “C. E.” indicates “Comparative example”, and the ratio of the lines passing through the portion M indicates the “ratio of a number of lines crossing the portion M, with respect to the 99 lines (%)”.

The ratio of the number of LS indicates the “ratio of a number of line segments LS of which length is 20 μm or more, with respect to the total number of lines segments LS (%)”.

The ratio of the portion E indicates the “ratio of the portion E existing directly under the portion C with respect to the number of portions C (%)”.

The low frequency impedance indicates the impedance when the frequency is 1.0×10⁻² to 1.0×10¹ Hz. The high frequency impedance slope indicates the slope when the frequency is 1.0×10⁵ to 1.0×10⁶ Hz.

The present disclosure can provide a conductive roller that can form high quality images over a long period of time, even when this conductive roller is applied to the electrophotographic image forming process of the main body having a longer service life, without performing pre-exposure and faster speed. Also, the present disclosure can provide a process cartridge to form high quality electrophotographic images. Furthermore, the present disclosure can provide an electrophotographic image forming apparatus that can form high quality electrophotographic images.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-014185, filed Jan. 30, 2025, and Japanese Patent Application No. 2026-004514, filed Jan. 14, 2026, which are hereby incorporated by reference herein in their entirety.

What is claimed is:

1. A conductive roller, comprising:
a support member having a conductive outer surface; and
a conductive layer disposed on the outer surface of the support member, wherein
the conductive layer comprises a matrix which comprises first rubber, and a plurality of domains dispersed in the matrix, wherein
volume resistivity of the matrix is 1.00×10⁸ to 1.00×10¹² Ω·cm,
the plurality of domains comprises a plurality of domains A, and
each of the domains A satisfies <Condition 1> to <Condition 3> below:
<Condition 1> each domain A has a core-shell structure constituted of a core and a shell surrounding the core, the core comprises second rubber, which is different from the first rubber, and an electronic conductive agent, and the shell comprises third rubber, which is different from the first rubber and the second rubber;
<Condition 2> a centroid of volume of each domain A exists inside the core of the domain A;
<Condition 3> on a cross section of each domain A passing through the centroid of volume, volume resistivity of the core of the domain A is not more than 1.00×10⁴ Ω·cm, and volume resistivity of the shell is more than 1.00×10¹² Ω·cm; wherein
in a case where a platinum electrode is directly disposed on an outer surface of the conductive roller, impedance is measured by applying AC voltage having a 1V amplitude between the outer surface of the support member and the platinum electrode in an environment of a 23° C. temperature and 50% relative humidity, while changing a frequency in a range of 1.0×10⁻² to 1.0×10⁷ Hz, and the frequency is plotted on an abscissa and the impedance is plotted on an ordinate of a log-log graph, a slope at the frequency range of 1.0×10⁵ to 1.0×10⁶ Hz is −0.80 to −0.30, and the impedance in the frequency range of 1.0×10⁻² to 1.0×10¹ Hz is 1.00×10³ to 1.00×10⁷Ω, wherein
the outer surface of the conductive layer is constituted of a portion M originated from the matrix, and a portion D originated from the domain, and in a case where a 100 μm square observation region is disposed on the outer surface of the conductive layer, such that one side of the square is parallel with a circumferential direction of the conductive roller, at a total of 12 locations of the center of L (L is the length of the conductive layer in a longitudinal direction) and L/4 from each end toward the center at 90° intervals in the circumferential direction, and in this state, a ratio (R2/R1), which is a ratio of an area R2 where the portion D occupies with respect to an area R1 where the portion M occupies in the observation region, is at least 0.50, wherein
in a case where 99 lines are drawn in the observation region, along a rotation shaft of the conductive roller, at 1 μm intervals in the circumferential direction of the conductive roller, a plurality of lines, out of the lines, cross the portion M, and in a case where in each line crossing the portion M, a line portion overlapping with the portion M is assumed to be a line segment LS, a ratio of the number of line segments LS, of which length is at least 20 μm, with respect to the total number of line segments LS, is not more than 5%, and wherein
in a case where a portion containing the second rubber and the electronic conductive agent, out of the portion D, is assumed to be a portion C, a portion E which contains the third rubber exists directly under the portion C on the outer surface of the conductive layer in a cross-sectional view of the conductive layer in a thickness direction thereof.

2. The conductive roller according to claim 1, wherein a ratio of the portion E existing directly under the portion C, with respect to a number of portions C, is at least 75%.

3. The conductive roller according to claim 1, wherein
a ratio of a number of lines crossing the portion M out of the 99 lines is at least 10%.

4. The conductive roller according to claim 1, wherein
in the cross-sectional observation of the conductive layer, a ratio of a cross-sectional area of the electronic conductive agent contained in the core, with respect to the cross-sectional area of the core, is at least 20.0 area %.

5. The conductive roller according to claim 1, wherein
the electronic conductive agent is carbon black.

6. The conductive roller according to claim 1, wherein
a ratio of a number of the domains A with respect to the total number of the domains is at least 60 number %.

7. The conductive roller according to claim 1, wherein
the first rubber is at least one rubber selected from the group consisting of acrylonitrile-butadiene rubber, chloroprene rubber and hydrin rubber.

8. The conductive roller according to claim 1, wherein
the second rubber is at least one rubber selected from the group consisting of natural rubber, butadiene rubber, butyl rubber, acrylonitrile-butadiene rubber, urethane rubber, silicon rubber, fluoro rubber, isoprene rubber, chloroprene rubber, styrene-butadiene rubber, ethylene-propylene rubber and polynorbornene rubber.

9. The conductive roller according to claim 1, wherein
the third rubber is at least one rubber selected from the group consisting of natural rubber, butadiene rubber, butyl rubber, isoprene rubber, styrene-butadiene rubber and ethylene-propylene rubber.

10. The conductive roller according to claim 1, wherein
the first rubber is acrylonitrile butadiene rubber,
the second rubber is styrene-butadiene rubber, and
the third rubber is at least one rubber selected from the group consisting of ethylene-propylene rubber, isoprene rubber and butadiene rubber.

11. A process cartridge detachably attached to a main body of an electrophotographic image forming apparatus,
the process cartridge, comprising:
an electrophotographic photosensitive member; and a charging member disposed such that the electrophotographic photosensitive member is chargeable, wherein
the charging member is a conductive roller, comprising:
a support member having a conductive outer surface; and
a conductive layer disposed on the outer surface of the support member, wherein
the conductive layer comprises a matrix which comprises first rubber, and a plurality of domains dispersed in the matrix, wherein
volume resistivity of the matrix is 1.00×10⁸ to 1.00×10¹² Ω·cm,
the plurality of domains comprises a plurality of domains A, and
each of the domains A satisfies <Condition 1> to <Condition 3> below:
<Condition 1> each domain A has a core-shell structure constituted of a core and a shell surrounding the core, the core comprises second rubber, which is different from the first rubber, and an electronic conductive agent, and the shell comprises third rubber, which is different from the first rubber and the second rubber;
<Condition 2> a centroid of volume of each domain A exists inside the core of the domain A;
<Condition 3> on a cross section of each domain A passing through the centroid of volume, volume resistivity of the core of the domain A is not more than 1.00×10⁴ Ω·cm, and volume resistivity of the shell is more than 1.00×10¹² Ω·cm; wherein
in a case where a platinum electrode is directly disposed on an outer surface of the conductive roller, impedance is measured by applying AC voltage having a 1V amplitude between the outer surface of the support member and the platinum electrode in an environment of a 23° C. temperature and 50% relative humidity, while changing a frequency in a range of 1.0×10⁻² to 1.0×10⁷ Hz, and the frequency is plotted on an abscissa and the impedance is plotted on an ordinate of a log-log graph, a slope at the frequency range of 1.0×10⁵ to 1.0×10⁶ Hz is −0.80 to −0.30, and the impedance in the frequency range of 1.0×10⁻² to 1.0×10¹ Hz is 1.00×10³ to 1.00×10⁷Ω, wherein
the outer surface of the conductive layer is constituted of a portion M originated from the matrix, and a portion D originated from the domain, and in a case where a 100 μm square observation region is disposed on the outer surface of the conductive layer, such that one side of the square is parallel with a circumferential direction of the conductive roller, at a total of 12 locations of the center of L (L is the length of the conductive layer in a longitudinal direction) and L/4 from each end toward the center at 90° intervals in the circumferential direction, and in this state, a ratio (R2/R1), which is a ratio of an area R2 where the portion D occupies with respect to an area R1 where the portion M occupies in the observation region, is at least 0.50, wherein
in a case where 99 lines are drawn in the observation region, along a rotation shaft of the conductive roller, at 1 μm intervals in the circumferential direction of the conductive roller, a plurality of lines, out of the lines, cross the portion M, and in a case where in each line crossing the portion M, a line portion overlapping with the portion M is assumed to be a line segment LS, a ratio of the number of line segments LS, of which length is at least 20 μm, with respect to the total number of line segments LS, is not more than 5%, and wherein
in a case where a portion containing the second rubber and the electronic conductive agent, out of the portion D, is assumed to be a portion C, a portion E which contains the third rubber exists directly under the portion C on the outer surface of the conductive layer in a cross-sectional view of the conductive layer in a thickness direction thereof.

12. An electrophotographic image forming apparatus, comprising: an electrophotographic photosensitive member; and a charging roller disposed such that the electrophotographic photosensitive member is chargeable, wherein
the charging roller is a conductive roller, comprising:
a support member having a conductive outer surface; and
a conductive layer disposed on the outer surface of the support member, wherein
the conductive layer comprises a matrix which comprises first rubber, and a plurality of domains dispersed in the matrix, wherein
volume resistivity of the matrix is 1.00×10⁸ to 1.00×10¹² Ω·cm,
the plurality of domains comprises a plurality of domains A, and
each of the domains A satisfies <Condition 1> to <Condition 3> below:
<Condition 1> each domain A has a core-shell structure constituted of a core and a shell surrounding the core, the core comprises second rubber, which is different from the first rubber, and an electronic conductive agent, and the shell comprises third rubber, which is different from the first rubber and the second rubber;
<Condition 2> a centroid of volume of each domain A exists inside the core of the domain A;
<Condition 3> on a cross section of each domain A passing through the centroid of volume, volume resistivity of the core of the domain A is not more than 1.00×10⁴ Ω·cm, and volume resistivity of the shell is more than 1.00×10¹² Ω·cm; wherein
in a case where a platinum electrode is directly disposed on an outer surface of the conductive roller, impedance is measured by applying AC voltage having a 1V amplitude between the outer surface of the support member and the platinum electrode in an environment of a 23° C. temperature and 50% relative humidity, while changing a frequency in a range of 1.0×10⁻² to 1.0×10⁷ Hz, and the frequency is plotted on an abscissa and the impedance is plotted on an ordinate of a log-log graph, a slope at the frequency range of 1.0×10⁵ to 1.0×10⁶ Hz is −0.80 to −0.30, and the impedance in the frequency range of 1.0×10⁻² to 1.0×10¹ Hz is 1.00×10³ to 1.00×10⁷Ω, wherein
the outer surface of the conductive layer is constituted of a portion M originated from the matrix, and a portion D originated from the domain, and in a case where a 100 μm square observation region is disposed on the outer surface of the conductive layer, such that one side of the square is parallel with a circumferential direction of the conductive roller, at a total of 12 locations of the center of L (L is the length of the conductive layer in a longitudinal direction) and L/4 from each end toward the center at 90° intervals in the circumferential direction, and in this state, a ratio (R2/R1), which is a ratio of an area R2 where the portion D occupies with respect to an area R1 where the portion M occupies in the observation region, is at least 0.50, wherein
in a case where 99 lines are drawn in the observation region, along a rotation shaft of the conductive roller, at 1 μm intervals in the circumferential direction of the conductive roller, a plurality of lines, out of the lines, cross the portion M, and in a case where in each line crossing the portion M, a line portion overlapping with the portion M is assumed to be a line segment LS, a ratio of the number of line segments LS, of which length is at least 20 μm, with respect to the total number of line segments LS, is not more than 5%, and wherein
in a case where a portion containing the second rubber and the electronic conductive agent, out of the portion D, is assumed to be a portion C, a portion E which contains the third rubber exists directly under the portion C on the outer surface of the conductive layer in a cross-sectional view of the conductive layer in a thickness direction thereof.
